(19) United States
(12) Patent Application Publication
(10) Pub. No.: US 2026/0219692 A1
(43) Pub. Date: Jul. 30, 2026

(54) SYSTEMS AND METHODS FOR PULLING

(71) Applicant: Anat de Picciotto, Shchenya (IL)

(72) Inventor: Anat de Picciotto, Shchenya (IL)

(73) Assignee: Anat de Picciotto, Shchenya (IL)

(21) Appl. No.: 19/146,527

(22) PCT Filed: Jan. 9, 2024
(86) PCT No.: PCT/IL2024/050029

§ 371 Date: Jul. 9, 2025

Related U.S. Application Data
(60) Provisional application No. 63/479,546, filed on Jan. 12, 2023.
(60) Provisional application No. 63/511,688, filed on Jul. 3, 2023.

(51) Int. Cl. G05D 1/672; G05D 109/20

(52) U.S. Cl. CPC G05D 1/672; G05D 2109/20

(57) ABSTRACT

This invention relates to systems and methods for pulling, transferring, marking, and covering. Methods of this invention utilize drone(s) to pull/transfer an elongated element over an object, over a surface or over any combination thereof. Further, methods of this invention utilize drone(s) and an elongated element to mark, cover or coat an object, a surface, or any combination thereof.

### TECHNOLOGICAL FIELD

This invention relates to systems and methods for pulling, placing, transferring, marking, and covering. Methods of this invention utilize drone(s) to transfer/pull an elongated element over an object, over a surface or over any combination thereof. Further, methods of this invention utilize drone(s) and an elongated element to mark, cover or coat an object, a surface, or any combination thereof.

### BACKGROUND

There are numerous objects and surfaces that require coverage or coating. When these objects or surfaces are of a large area (such as an agricultural field or a water reservoir) or are high (such as trees or buildings) or are located at a non-accessible or hardly-accessible terrain (such as military logistics and supply bases), covering of their surfaces is challenging. When required, such coverage utilizes manual work, and many times the surface must be divided into smaller portions wherein each portion is covered separately. Some objects/surfaces cannot be covered at all using existing methods.

As noted above, the ability to cover large areas and objects efficiently and quickly would provide major contribution in fields such as agriculture, construction, logistics, military, environmental and ecological fields.

There are also numerous situations that require transfer of supplies to a certain area. For example, transfer of supplies to a disaster area, transfer of nutrients to agricultural fields, transfer of supplies to humans or animals situated in an area that is not accessible by foot or by car, etc. When transfer is required over a long distance or a substantial height, such transfer is challenging. When required, such transfer utilizes manual work, and in some instances such transfer is not possible at all using existing methods.

As noted above, the ability to transfer supplies to remote or hardly accessible areas or to an area of a very large dimension, efficiently and quickly, would provide major contribution in fields such as agriculture, rescue, construction, logistics, military, environmental and ecological fields.

Similarly, the marking of an area such as the areas noted herein above is also currently challenging. As noted above, the ability to transfer a marking feature over an area to be marked or over an area of a very large dimension, efficiently and quickly, would provide major contribution in the various fields as noted herein above.

### SUMMARY

In one embodiment, this invention provides systems and methods for pulling and/or for transferring an elongated element over a surface, an area or an object. In one embodiment, this invention provides systems and methods for marking and/or for covering a surface, an area, or an object. In one embodiment, this invention provides systems and methods for pulling an elongated element. In one embodiment, this invention provides systems and methods for pulling an elongated element over a surface or over an object. In one embodiment, this invention provides systems and methods for covering large objects or large surfaces. In one embodiment, systems and methods of this invention utilize drone(s) to pull/transfer a covering element over a surface or over an object, thus efficiently covering the surface or the object. In one embodiment, using drone(s) to pull an elongated element, enables to cover and/or to mark large, tall, or long surfaces in a fast and efficient manner. In one embodiment, pulling methods of this invention allow transfer of supplies to areas that are not accessible by foot or by car.

In one embodiment, this invention provides a method for covering at least one surface, at least one object or a combination thereof, said method comprising:
providing a system comprising:
at least one drone;
a roller connected to said drone;
an elongated element comprising a first end and a second end, said element is wrapped around said roller;
a drone-control device;
   wherein said first end of said elongated element is connected to said roller;
   said second end of said elongated element is configured to be connected to an external anchor point/region located on an object external to said drone;
   wherein when said elongated element is connected to said external anchor point/region, and when said drone is moving, the drone is capable of pulling said elongated element over at least one surface, at least one object or a combination thereof;
connecting said second end of said elongated element to said external anchor point/region;
using said drone-control device to move said drone, such that said drone pulls said elongated element over said at least one surface, over said at least one object or a combination thereof, thus covering said at least one surface, said at least one object or a combination thereof.

In one embodiment, this invention provides a method for pulling an elongated object, said method comprising:
providing a system comprising:
   at least one drone;
   a roller connected to said drone;
   an elongated element comprising a first end and a second end, said element is wrapped around said roller;
   a drone-control device;
wherein said first end of said elongated element is connected to said roller;
said second end of said elongated element is configured to be connected to an external anchor point located on an object external to said drone;
wherein when said elongated element is connected to said anchor point, and when said drone is moving, the drone is capable of pulling said elongated element over at least one surface, at least one object or a combination thereof, and wherein at least a portion of the drone's movement is a non-vertical movement;
   attaching said second end of said elongated element to said external anchor point;
   using said drone-control device to move said drone, such that said drone pulls said elongated element over said at least one surface, over said at least one object or a combination thereof, wherein at least a portion of said drone's movement is a non-vertical movement.

In one embodiment, this invention provides a method for covering at least one surface, at least one object or a combination thereof, the method comprising:
providing a system comprising:
   at least one drone;
   a roller connected to said drone;
   an elongated element comprising a first end and a second end, said element is wrapped around said roller;
   a drone-control device;
wherein said first end of said elongated element is connected to said roller;
wherein said second end of said elongated element is configured to be connected to an external anchor point/region located on an object external to said drone;
wherein when said elongated element is connected to said anchor point/region, and when said drone is moving, the drone is capable of pulling said elongated element over at least one surface, at least one object or a combination thereof, and wherein at least a portion of the drone's movement is a non-vertical movement;
   attaching said second end of said elongated element to said external anchor point/region;
   using said drone-control device to move said drone, such that said drone pulls said elongated element over said at least one surface, over said at least one object or a combination thereof, wherein at least a portion of said drone's movement is a non-vertical movement.

In one embodiment, the drone-control device controls the movement of said drone. In one embodiment, the drone pulls said covering elements over a predetermined surface. In one embodiment, the drone pulls said covering element over a field, over a tree, over a line of trees, over an orchard, over a bush, over a line of bushes, over a field of bushes, over a building, over a line of buildings, over a region of buildings, over a geographical area, over a mountain, over a cliff, over a river, over a logistical area, over a water reservoir, over a car lot, over a truck lot, over a road, over a street, over a forest, over an army unit, over an army base, over a supply camp, over an assembly area, over a gathering area, over a storage area, over a territory, over a piece of land, over an area, over a lot, over a yard, over a portion of the ground, over a balcony, or over any portion or any combination thereof. In one embodiment, the drone pulls the covering element over an item selected from a list consisting of the items described in the list herein above. In one embodiment, methods of this invention are used to gather or to rescue animal(s). In one embodiment, the drone pulls said covering element over an animal, or over a group of animals.

In one embodiment, the drone is capable of moving in any direction. In one embodiment, the drone is capable of moving in multiple directions. In one embodiment, the movement of said drone is selected from: up, down, horizontally at any direction, in a straight line, forming a circular pattern, forming an oval pattern, forming a square, forming a rectangle, a sinusoidal form, or any combination thereof. In one embodiment, the connection of said roller to said first end of said covering element comprises: connection of said roller to one anchor point on said first end, to two anchor points on said first end, to more than two anchor points on said first end, to a line on said first end, to at least one patch on said first end, to at least one region on said first end, or a combination thereof.

In one embodiment, the elongated element is in the form of a roll wound on said roller.

In one embodiment, the at least one drone comprises two drones such that each of said two drones is independently connected to a different portion of said roller, and wherein when said elongated element is connected to an external anchor point, said two drones simultaneously pull said roller, thus pulling said elongated element.

In one embodiment, the external anchor point is located on an external elevated fixture, such that the height of said anchor point is higher than the surface or the object over which said elongated element is pulled.

In embodiments of a method of this invention:
said elongated element is in the form of an elongated sheet and said elongated sheet is rolled on said roller;
said second end of said elongated element is connected to said external anchor point located on an external elevated fixture, such that the height of said anchor point is higher than the surface or the object over which said elongated element is pulled;
said at least one drone pulls said elongated element over said surface or over said object, or over any combination thereof.

In one embodiment, the drone pulls said elongated element as follows:
pulling up next to a first side of at least one object;
pulling over said object, to a side opposing said first side;
optionally pulling down along said opposing side.

In one embodiment, following positioning of said elongated element over said surface/object:
a portion of said elongated element is disconnected from said roller; or
said drone disconnects from said roller; or
said drone lands on an area proximal to said surface/said object; or
a combination thereof.

In embodiments of a method pf this invention:
following disconnection of a portion of said elongated element from said roller; or
following disconnection of said drone from said roller; or
a combination thereof,
said drone returns home (RH).

In embodiments of a method pf this invention:
a portion of said elongated element, proximal to said roller is cut, such that a remaining portion of said elongated element remains wound on said roller; or
said first end of said elongated element is disconnected from said roller.

In one embodiment, any of said disconnections is automatically performed by the drone or wherein any of said disconnections is performed manually.

In one embodiment, any of said disconnections is automatically performed by the drone or wherein any of said disconnections is performed manually.

In one embodiment, the elongated element is in the form of a stripe, a cord, a tube, a wire, a cable, or a hose.

In one embodiment, the covering method is used for an application selected from: protecting fruit on fruit-trees from birds and/or from insects/pests, protecting a surface from sun/rain/wind/moisture, protecting a liquid reservoir from liquid evaporation, camouflage a military assembly, mark a region or an area for spraying, planting, seeding, mark an area for airplane landing, mark an area for landscaping, defining borders between geographical/farming regions, protecting a seeded area from pests/insects, protecting a crop region from pests/insects, selective seeding or planting in portions of a field, selective irrigation of portions of a field, protecting a building during renovation, decorating a building, generating a roof over a building/structure, generating walls for a building/structure, transferring water/electricity/supplies to remote or inaccessible areas, or any combination thereof. In one embodiment, methods of this invention are used to gather or to catch animal(s). In one embodiment, methods of this invention are used for rescuing an animal or a group of animals. In one embodiment, the drone pulls said covering element over an animal, or over a group of animals. In one embodiment, the drone is capable of moving in any and in all directions.

In one embodiment, the movement of the drone comprises a movement selected from: up, down, partially up, partially down, horizontally at any direction, in a straight line, in a spiral mode, a zig-zag, a circle, a square, a triangle, a sawtooth wave form, a sinusoidal form, a random movement, an arbitrary movement at any angle between 0 degrees and 90 degrees corresponding to the land's surface, at any angle between 0 degrees and 180 degrees corresponding to the land's surface, at 360 degrees around, or any combination thereof.

In one embodiment, the roller is connected to one anchor point/region, or to two anchor points/regions, or to more than two anchor points/regions, on said first end of said elongated element.

In one embodiment, the elongated element is a roll wound on said roller.

In one embodiment, one or more of the disconnections described herein above is automatically performed by the drone. In one embodiment, one or more of the disconnections described herein above is performed manually.

In one embodiment, the elongated element is in the form of a stripe, a cord, a tube, a cable, a wire, or a hose.

In one embodiment, this invention provides a system for pulling an elongated element, said system comprising:
at least one drone;
a roller connected to said drone;
an elongated element comprising a first end and a second end, said element is wrapped around said roller;
a drone-control device;
wherein said first end of said elongated element is connected to said roller;
wherein said second end of said elongated element is configured to be connected to an external anchor point/region located on an object external to said drone;
wherein when said elongated element is connected to said anchor point/region, and when said drone is moving, the drone is capable of pulling said elongated element over at least one surface, over at least one object or a combination thereof, and wherein at least a portion of the drone's movement is a non-vertical movement.

In one embodiment, this invention provides a system for covering at least one surface, at least one object or a combination thereof, said system comprising:
at least one drone;
a roller connected to said drone;
an elongated element comprising a first end and a second end, said element is wrapped around said roller;
a drone-control device;
wherein the first end of the elongated element is connected to the roller;
wherein said second end of said elongated element is configured to be connected to an external anchor point/region located on an object external to said drone;
wherein when said elongated element is connected to said external anchor point/region, and when said drone is moving, the drone is capable of pulling said elongated element over at least one surface, at least one object or a combination thereof, and wherein at least a portion of the drone's movement is a non-vertical movement.

In one embodiment, the second end of said elongated element, said external anchor point/region or a combination thereof comprises a connection element, a connection point, an anchor point, an anchor element, a connection/anchor region, or any combination thereof. In one embodiment, the system further comprising a bifunctional connection element configured to be connected to:
said second end of said elongated element; and to
said external anchor point/region;
thus connecting said elongated element to said external anchor point/region.

In one embodiment, the second end of said elongated element, said external anchor point/region, said bifunctional connection element or any combination thereof comprises a hook, a magnet, a button, a loop, a hole, a fastener, a Velcro® attachment, a rope, a string, a cord, a stripe, a thread, a zipper, a chain, a ring, a tape, a sticky tape, a vacuum element, a crocodile clip, a clip, a belt, a closure, an arm, a bolt, a nail, a nut, a pole a rod, a depression, an indentation, a protrusion, a bump, a bulge, a link, a lock, a holder, a hollow channel or any portion or combination thereof.

In one embodiment, the elongated element comprises a sheet, a cord, a stripe, a hose, a rope, a tube, a conduit, a web, a fabric, a blanket, a woven material, a foil, a net, a sponge, a plastic sheet, a cloth, a paper, or any combination thereof. In one embodiment, the elongated element is made of a material comprising a polymer. In one embodiment, the polymer is organic, inorganic or any combination thereof. In one embodiment, the material further comprises a metal, an alloy, small molecules, or any combination thereof.

In one embodiment, the length of said elongated element ranges between 1 m-10 m, or between 1 m-100 m, or between 1 m-1000 m, or between 1 m and 10,000 m.

In one embodiment, the width of said elongated element ranges between 0.0001 m-1 m, or between 0.001 m-1 m, or between 0.001 m-0.1 m, or between 0.01 m-1 m, or between 0.1 m-1 m, or between 0.1 m-10 m, or between 1 m-10 m, or between 1 m-100 m, or between 1 m-500 m, or between 0.001 m-100 m, or between 0.05 m-100 m.

In one embodiment, the thickness of said elongated element ranges between 10 μm-100 μm, or between 100 μm and 1 mm, or between 1 mm and 1 cm or between 1 cm and 10 cm, or between 10 μm-20 cm. In one embodiment, the thickness of said elongated element ranges between 10 μm-2 cm. In one embodiment, the thickness of said elongated element ranges between 10 μm-5 cm. In one embodiment, the thickness of said elongated element ranges between 10 μm-10 cm.

In one embodiment, the elongated element has a circular or an oval cross-section, and wherein at least one dimension of said cross-section ranges between 10 μm-100 μm, or between 100 μm and 1 mm, or between 1 mm and 1 cm or between 1 cm and 10 cm, or between 10 μm-20 cm. In one embodiment, at least one dimension of said cross-section ranges between 10 μm-5 cm.

In one embodiment, the elongated element has a rectangular cross-section, wherein the width of said cross section as defined herein below is larger than the thickness of said cross section, and wherein at least one dimension of said cross-section ranges between 10 μm-100 μm, or between 100 μm and 1 mm, or between 1 mm and 1 cm or between 1 cm and 10 cm, or between 10 μm-2 cm or between 10 μm-20 cm. In one embodiment, at least one dimension of said cross-section ranges between 10 μm-5 cm.

In one embodiment, the drone is capable of pulling/transferring at least 0.5 kg, or at least 6 kg, or at least 10 kg. In one embodiment, the drone is capable of pulling/transferring at least 20 kg.

In one embodiment, the elongated element is in the form of a sheet, and wherein the weight of said sheet is at least 10 g per 1 m² of sheet area, or between 20 g-120 g per 1 m² of sheet area, or between 50 g and 1000 g per 1 m² of sheet area.

In one embodiment, the elongated element or a portion thereof is waterproof. In one embodiment, the elongated element comprises two or more layers. In one embodiment, the elongated element or a portion thereof is transparent.

In one embodiment, the elongated element is at least partially luminescent, at least partially IR reflective, at least partially reflective of visible light, at least partially UV reflective or any combination thereof. In one embodiment, the elongated element absorbs at least a portion of the radiation at the IR range, absorbs at least a portion of the radiation at the visible light range, absorbs at least a portion of the radiation at the UV range or any combination thereof. In one embodiment, the elongated element transfers at least a portion of the radiation at the IR range, transfers at least a portion of the radiation at the visible light range, transfers at least a portion of the radiation at the UV range or any combination thereof.

In one embodiment, the elongated element comprises at least one of: electrical wire(s), electrical cord(s), electrical element(s), electrical component(s), a connection to a power supply/current generator, or any combination or any number thereof.

In one embodiment, the elongated element comprises at least one light source. In one embodiment, the light source is selected from a light emitting diode (LED), a lamp, or a combination thereof. In one embodiment, the light source is a luminescent light source. In one embodiment, the luminescent light source is a ‘stick light’. In one embodiment, the light source is a solar light source. In one embodiment, a series of light sources is configured/placed along the length of an elongated element. In one embodiment, the elongated element is configured to illuminate when a light source is connected to a power supply. In one embodiment, the elongated element is configured to illuminate when a light source is turned on.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates one embodiment of a system and a method of this invention; A drone (100) is connected to a roller (not shown); An elongated element (110) is mounted on said roller; The drone pulls the covering element over objects (120); A drone-control device (130) controls the movement of the drone; An anchor point/structure (140) is connected to the elongated element.

FIG. 2A and FIG. 2B show two embodiments of anchor points (connection points/elements) on an exposed end of an elongated element, configured to be connected to an anchor point/region external to the drone; FIG. 2A shows one anchor point (circle 250) located at, or proximal to, an exposed end of a covering/elongated element (210); FIG. 2B shows two anchor points (250) located at, or proximal to, an exposed end of a covering/elongated element (210);

FIG. 3 illustrates an embodiment of the invention, wherein two drones (300) pull a covering element to wrap around a set of poles (360);

FIG. 4 illustrates an embodiment of the invention, wherein one drone (400) pulls a covering element to wrap around a set of poles (460);

FIG. 5 illustrates an embodiment of the invention, wherein the covering/elongated element comprises a series of anchor points (two of which are shown by circles (570); the anchor points can be used to fasten the covering element on one or on both sides of a covered surface/object;

FIG. 6 illustrates an embodiment wherein an exposed end of a covering element is connected to a stand (680) and can be elevated to a certain height; the covering element is rolled on a roller connected to at least one drone (600) (two drones in the image);

FIG. 7 illustrates an embodiment of the invention, wherein at least one drone (two drones in the image) pulls a covering element to cover the top of a structure and optionally its sides; a set of poles (790) and a top construction of beams (792) are illustrated.

FIG. 8A and FIG. 8B show two embodiments of a covering element wrapped around a roller connected to at least one drone; FIG. 8A illustrates one drone (800) connected to a roller (802), the roller is connected at two points to the drone; a connection element (804) connects the roller to the drone; a covering element (810) is wrapped around the roller; an exposed edge of a covering element is shown (covering element is in the form of a rolled sheet or a rolled stripe for example);

FIG. 8B illustrates two drones (800) connected to a roller (802), the roller is connected at one point to a first drone, and at another point to a second drone; two connection elements (804) connects the roller to the drones; a covering element (810) is wrapped around the roller; an exposed edge of a covering element is shown at the right side of the image;

FIG. 9A and FIG. 9B illustrate two embodiments of a roller extending vertically down from a drone (900). FIG. 9A, the roller is connected at one point to a first top drone, and at another point to a second bottom drone; FIG. 9B, the roller is connected at one point to one top drone, and at another point to a stopper (994); a covering element as shown in previous figures is wrapped around the roller; an exposed edge of a covering element is shown at the right side of FIG. 9A and of FIG. 9B.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The presently disclosed subject matter may be understood more readily by reference to the following detailed description which forms a part of this disclosure. It is to be understood that the presently disclosed subject matter is not limited to the specific products, methods, conditions, or parameters described and/or shown herein, and that the terminology used herein is for the purpose of describing particular embodiments by way of example only and is not intended to be limiting of the presently disclosed subject matter. In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In one embodiment, this invention provides systems and methods designed to conveniently mark and cover surfaces. In one embodiment, this invention provides systems and methods designed to conveniently pull an elongated element over a surface or over an object. The systems and methods of this invention utilize drones to pull a covering element over surfaces. In one embodiment, coverage methods of this invention are particularly useful when a surface to be covered is tall, long, or large. In such cases, covering the object manually is not possible or is difficult and complicated. In one embodiment, coverage methods of this invention are particularly useful when the object/surface to be covered, is located in a non-accessible area or when accessibility to the area of the object/surface is limited. Examples of surfaces/objects that can be covered by methods of this invention include, but are not limited to crop lines in a field, trees in an orchard, buildings, construction sites, military gathering areas, open warehouses etc. This invention provides systems and methods that enable to pull a cord, a cable, a tube or a hose over a surface or over an object, thus delivering water or electricity to an inaccessible area. Accordingly, systems and methods of this invention may be utilized in disaster areas for rescue. Additional embodiments of systems and methods of this invention and their uses are described herein below.

### Methods of this Invention

In one embodiment, this invention provides a method for pulling an elongated object, said method comprising:
providing a system comprising:
   at least one drone;
   a roller connected to said drone;
   an elongated element comprising a first end and a second end, said element is wrapped around said roller;
   a drone-control device;
wherein said first end of said elongated element is connected to said roller;
said second end of said elongated element is configured to be connected to an external anchor point located on an object external to said drone;
wherein when said elongated element is connected to said anchor point, and when said drone is moving, the drone is capable of pulling said elongated element over at least one surface, at least one object or a combination thereof;
   attaching said second end of said elongated element to said external anchor point;
   using said drone-control device to move said drone, such that said drone pulls said elongated element over said at least one surface, over said at least one object or a combination thereof.

In one embodiment, this invention provides a method for pulling an elongated object, said method comprising:
providing a system comprising:
   at least one drone;
   a roller connected to said drone;
   an elongated element comprising a first end and a second end, said element is wrapped around said roller;
   a drone-control device;
wherein said first end of said elongated element is connected to said roller;
said second end of said elongated element is configured to be connected to an external anchor point located on an object external to said drone;
wherein when said elongated element is connected to said anchor point, and when said drone is moving, the drone is capable of pulling said elongated element over at least one surface, at least one object or a combination thereof, and wherein at least a portion of the drone's movement is a non-vertical movement;
   attaching said second end of said elongated element to said external anchor point;
   using said drone-control device to move said drone, such that said drone pulls said elongated element over said at least one surface, over said at least one object or a combination thereof, wherein at least a portion of said drone's movement is a non-vertical movement.

In one embodiment, this invention provides a method for covering at least one surface, at least one object or a combination thereof, the method comprising:
providing a system comprising:
   at least one drone;
a roller connected to said drone;
an elongated element comprising a first end and a second end, said element is wrapped around said roller;
a drone-control device;
wherein said first end of said elongated element is connected to said roller;
   wherein said second end of said elongated element is configured to be connected to an external anchor point/region located on an object external to said drone;
   wherein when said elongated element is connected to said anchor point/region, and when said drone is moving, the drone is capable of pulling said elongated element over at least one surface, at least one object or a combination thereof;
attaching said second end of said elongated element to said external anchor point/region;
using said drone-control device to move said drone, such that said drone pulls said elongated element over said at least one surface, over said at least one object or a combination thereof.

In one embodiment, this invention provides a method for covering at least one surface, at least one object or a combination thereof, the method comprising:
providing a system comprising:
   at least one drone;
   a roller connected to said drone;
   an elongated element comprising a first end and a second end, said element is wrapped around said roller;
   a drone-control device;
wherein said first end of said elongated element is connected to said roller;
   wherein said second end of said elongated element is configured to be connected to an external anchor point/region located on an object external to said drone;
   wherein when said elongated element is connected to said anchor point/region, and when said drone is moving, the drone is capable of pulling said elongated element over at least one surface, at least one object or a combination thereof, and wherein at least a portion of the drone's movement is a non-vertical movement;
attaching said second end of said elongated element to said external anchor point/region;
using said drone-control device to move said drone, such that said drone pulls said elongated element over said at least one surface, over said at least one object or a combination thereof, wherein at least a portion of said drone's movement is a non-vertical movement.

In one embodiment, the drone-control device controls the movement of said drone.

In one embodiment, the drone pulls said elongated element over a predetermined surface. In one embodiment, the drone pulls said elongated element over a field, over a tree, over a line of trees, over an orchard, over a bush, over a line of bushes, over a field of bushes, over a building, over a line of buildings, over a region of buildings, over a geographical area, over a cliff, over a mountain, over a river, over a logistical area, over a water reservoir, over a car lot, over a truck lot, over a road, over a street, over a forest, over an army unit, over an army base, over a supply camp, over an assembly area, over a gathering area, over a storage area, over a territory, over a piece of land, over an area, over a lot, over a yard, over a portion of the ground, over a balcony, or over any portion or any combination thereof. In one embodiment, the drone pulls the covering element over an item selected from a list consisting of the items described in the list herein above. In one embodiment, methods of this invention are used to gather or to catch animal(s). In one embodiment, methods of this invention are used for rescuing an animal or a group of animals. In one embodiment, the drone pulls said covering element over an animal, or over a group of animals.

In one embodiment, the drone is capable of moving in any and in all directions.

In one embodiment, the movement of said drone is selected from: up, down, horizontally at any direction, in a straight line, forming a circular pattern, forming an oval pattern, forming a square, forming a rectangle, a sinusoidal form, or any combination thereof.

In one embodiment, the movement of the drone comprises a movement selected from: up, down, partially up, partially down, horizontally at any direction, in a straight line, in a spiral mode, a zig-zag, a circle, a square, a triangle, a sawtooth wave form, a sinusoidal form, a random movement, an arbitrary movement at any angle between 0 degrees and 90 degrees corresponding to the land's surface, at any angle between 0 degrees and 180 degrees corresponding to the land's surface, at 360 degrees around, or any combination thereof.

In one embodiment, the roller is connected to one anchor point/region, or to two anchor points/regions, or to more than two anchor points/regions, on said first end of said elongated element. In one embodiment, the roller is connected to a line or to a patch, on said first end of said elongated element.

In one embodiment, the elongated element is a roll wound on said roller.

In one embodiment, the at least one drone comprises two drones such that each of said two drones is independently connected to a different portion of said roller, and wherein when said elongated element is connected to an external anchor point, said two drones simultaneously pull said roller, thus pulling said elongated element.

In one embodiment, the external anchor point is located on an external elevated fixture, such that the height of said anchor point is higher than the surface or the object over which said elongated element is pulled.

In one embodiment:
the elongated element is in the form of an elongated sheet and wherein said elongated sheet is rolled on said roller;
the second end of said elongated element is connected to said external anchor point/region located on an external elevated fixture, such that the height of said anchor point/region is higher than the surface or the object over which said elongated element is pulled;
the at least one drone pulls said elongated element over said surface or over said object, or over any combination thereof.

In one embodiment, the drone pulls said elongated element as follows:
pulling up next to a first side of at least one object;
pulling over said object, to a side opposing said first side;
optionally pulling down along said opposing side.

In one embodiment, following positioning of said elongated element over the surface/object:
a portion of said elongated element is disconnected from said roller; or
said drone disconnects from said roller; or
said drone lands on an area proximal to said surface/said object; or
a combination thereof.

In one embodiment:
following disconnection of a portion of said elongated element from said roller; or
following disconnection of said drone from said roller; or
a combination thereof, said drone returns home (RH).

In one embodiment, following positioning of said elongated element over the surface/object:
a portion of said elongated element, proximal to said roller is cut, such that a remaining portion of said elongated element remains wound on said roller; or
the first end of said elongated element is disconnected from said roller.

In one embodiment, any of the disconnections described herein above is automatically performed by the drone. In one embodiment, any of the disconnections described herein above is performed manually.

In one embodiment, the elongated element is in the form of a stripe, a cord, a tube, a wire, or a hose.

In one embodiment, the method is used for an application selected from: protecting fruit on fruit-trees from birds and/or from insects/pests, protecting a surface from sun/rain/wind/moisture/dryness/hail/snow, protecting a liquid reservoir from liquid evaporation, camouflage a military assembly, mark a region or an area for spraying, planting, seeding, mark an area for airplane landing, mark an area for landscaping, defining borders between geographical/farming regions, protecting a seeded area from pests/insects/weather conditions, protecting a crop region from pests/insects/weather conditions, selective seeding or planting in portions of a field, selective irrigation or spraying of portions of a field, protecting a building during renovation, decorating a building, generating a roof over a building/structure, generating walls for a building/structure, transferring water/electricity/supplies to remote or inaccessible areas, or any combination thereof. In one embodiment, methods of this invention are used for an application selected from a list consisting of the items in the list described herein above. In one embodiment, methods of this invention are used to gather or to catch animal(s). In one embodiment, methods of this invention are used for rescuing an animal or a group of animals. In one embodiment, the drone pulls said covering element over an animal, or over a group of animals.

In one embodiment, the movement of the drone with respect to a vertical line extending up from a point on the ground is selected from: up, down, forward, backward, left, right, or any combination thereof. In one embodiment, the movement of the drone is at any direction, in a straight line, forming a circular pattern, forming an oval pattern, forming a square, forming a rectangle, a sinusoidal form, or any combination thereof.

In one embodiment, the movement of the drone is selected from: up, down, horizontally at any direction, in a straight line, forming a circular pattern, forming an oval pattern, forming a square, forming a rectangle, a sinusoidal form, or any combination thereof.

In one embodiment, the movement of said drone is selected from: up, down, partially up, partially down, horizontally at any direction, in a straight line, in a spiral mode, a zig-zag, a circle, a square, a triangle, a sawtooth wave form, a sinusoidal form, a random movement, an arbitrary movement at any angle between 0 degrees and 90 degrees corresponding to the land's surface, at any angle between 0 degrees and 180 degrees corresponding to the land's surface, at 360 degrees around, or any combination thereof.

In one embodiment, the connection of said roller to said first end of said covering element comprises: connection of said roller to one anchor point, to two anchor points, to more than two anchor points, to a line, to at least one patch, to at least one region, or a combination thereof, on said first end of said covering element. In one embodiment, the elongated element is in the form of a roll wound on said roller.

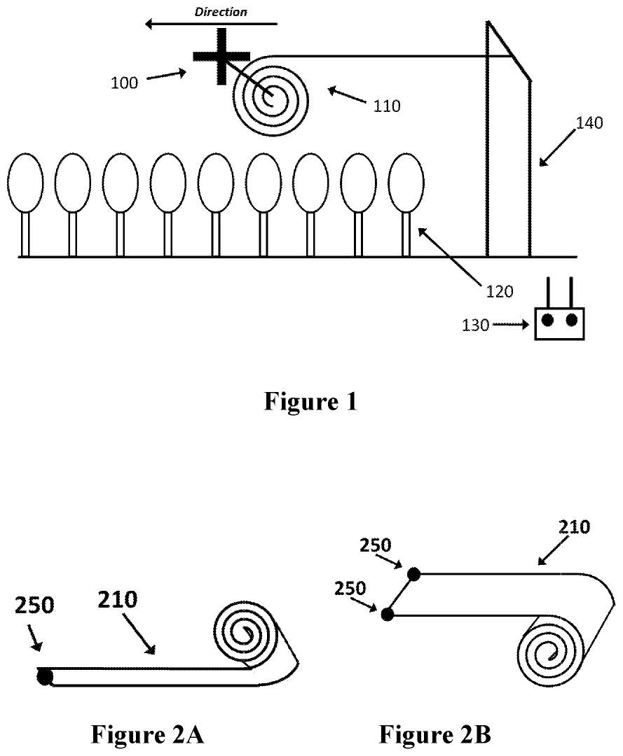

FIG. 1 shows an example of an embodiment, where the height of said anchor point is higher than the surface or the object over which said elongated element is pulled.

In one embodiment, the drone pulls the elongated element as follows:
pulling up next to a first side of at least one object;
pulling over said object, to a side opposing said first side;
optionally pulling down along said opposing side.

In one embodiment, following positioning of said elongated element over the surface/object:
a portion of said elongated element is disconnected from said roller; or
said drone disconnects from said roller; or
said drone lands on an area proximal to said surface/said object; or
a combination thereof.

In one embodiment, following positioning of said elongated element over said surface/object, any of said disconnections is automatically performed by the drone. In one embodiment, following positioning of said elongated element over said surface/object, any of said disconnections is performed manually.

In one embodiment, methods of this invention are used to cover the top of an object or a portion thereof. In one embodiment, methods of this invention are used to cover (or wrap) one or more sides of an object or a portion thereof. In one embodiment, methods of this invention are used to cover the top of an object or a portion thereof, and one or more sides of the object or a portion thereof. In one embodiment, methods of this invention are used to cover a green house. In one embodiment, covering the top of a construction according to methods of this invention creates a roof over the construction. In one embodiment, covering the sides of a construction according to methods of this invention creates walls for the construction.

In one embodiment, this invention provides a method for covering at least one surface, at least one object or a combination thereof, the method comprising:
providing an elongated covering element:
attaching at least one drone to the covering element;
operating the drone such that it moves and pulls the covering element over the at least one surface, the at least one object or a combination thereof, thus covering the surface and/or the object.

In one embodiment, the at least one drone comprises a first connection element/anchor point. In one embodiment, the elongated covering element comprises a second connection element/anchor point. In one embodiment, the first connection point on the drone is connected to the second connection point on the elongated element. In one embodiment, such connection is performed directly.

In one embodiment, such connection is performed using a third connection element that connects the first connection element to the second connection element. In one embodiment, a drone-control device is used to control the drone movement. In one embodiment, the first connection element on the drone is configured to be connected to the second connection element on the covering element thus connecting the drone to the covering element.

In one embodiment, the drone is capable of pulling the covering element over the at least one surface, over the at least one object or a combination thereof, thus covering the at least one surface, the at least one object or a combination thereof. In one embodiment, the drone is capable of pulling the covering element around at least one side of the at least one surface, over at least one side of the at least one object or a combination thereof, thus covering at least one side of the at least one surface, at least one side of the at least one object or a combination thereof.

In one embodiment, attaching the first connection element of the drone to the second connection element of the covering element, results in a connection between the drone and the covering element.

In one embodiment, using the drone-control device to move the drone, affects the drone to pull the covering element over the at least one surface, over the at least one object or over a combination thereof.

In one embodiment, systems of this invention further comprising a third connection element configured to be connected to the at least one drone and to the elongated covering element, thus connecting the drone to the covering element. In one embodiment, the third connection element is provided separately from the drone and separately from the covering element initially. In one embodiment, once the drone is placed next to the covering element, the third connection element connects the drone to the covering element. In one embodiment, once the drone is placed next to the covering element, the third connection element connects the first connection element (first anchor point) on the drone to the second connection element (second anchor point) on the covering element, thus connecting the drone to the covering element.

In one embodiment, following coverage of an object/surface as desired, or following assembly of a cord, wire, stripe, tube, hose on a certain area/object, the exposed end of the elongated element or any portion thereof is disengaged from the drone, e.g. by manual cutting, and the drone moves away from the disengaged portion of the elongated element. In one embodiment, such disengagement of the elongated element is performed manually. In one embodiment, such disengagement of the elongated element is performed automatically. In one embodiment, such automatic disengagement is triggered by a remote operator that commands operations of the drone using a drone-control device. A feature or features on the drone are assembled and configured to be remotely controlled to cut or disengage a region of the elongated element automatically. For autonomous drones, such disengagement can be pre-programmed, and the drone performs it according to information obtained by relevant sensors. The cutting of the elongated element may be made proximal to the roller, such that the rolled portion of the elongated element remains on the roller, or in a case where the entire elongated element has been used, the roller remains free of any portion of the elongated element. An end of the elongated element that may be made of the same or different material from the material that makes the elongated element, may remain attached to the roller in one embodiment. In embodiments of this invention, cutting the elongated element and disengaging a portion or all of it from the drone may be done using any cutting tool known in the art. In another embodiment, the elongated element comprises perforated areas or weakened areas that can be torn or ripped manually or by a feature on the drone that is utilized for that purpose. For very thin elongated element, a portion of the element can be torn or ripped manually with no need for a cutting tool. In some embodiments, following use or application of the elongated element according to methods of this invention, the roller itself disengages from the drone. In one embodiment, such disengagement is performed manually. In one embodiment, such disengagement is performed automatically by the drone (autonomous or remotely-controlled). In one embodiment, when pulling an elongated element connected to the drone is complete, or when covering or marking by an elongated element connected to the drone is complete, the drone drops the roller, while the drone is still in the air.

In one embodiment, methods of this invention utilize the drones indoors. In one embodiment, methods of this invention utilize the drones outdoors. In one embodiment, methods of this invention utilize the drones both indoors and outdoors.

In one embodiment, methods of this invention are used to stretch an elongated element in the air. According to this aspect and in one embodiment, the drone pulls the elongated element from a fixed point and through the air. According to this aspect and in one embodiment, stretching an elongated element in the air is utilized to catch an aerial object. According to this aspect and in one embodiment, stretching an elongated element in the air is utilized to stop an aerial object. According to this aspect and in one embodiment, the fixed point is connected directly or indirectly to the ground. According to this aspect and in one embodiment, the fixed point is connected to a ground, to a mount, to a tree, to a wall, to a fence, to a post, to a roof. In one embodiment, an elongated element is stretched vertically by the drone from the fixed point to which it is attached. According to this aspect and in one embodiment, an elongated element is first stretched vertically and then pulled horizontally by the drone with reference to the fixed point to which it is attached. According to this aspect and in one embodiment, the length of the stretched elongated element is oriented at any angle with respect to the ground's surface. In one embodiment, the elongated element is fixed on one end to a first drone and on another end to a second drone. According to this aspect, the elongated element is stretched in the air between the two drones. According to this aspect and in one embodiment, the elongated element is rolled on a roller connected to the first drone, and an edge of the elongated element is withdrawn from the roller and connected to the second drone. In one embodiment, both drones comprise a roller, and the elongated element is rolled on one roller on one side and on the other roller on the other side.

Applications and Uses of Methods of this Invention

In one embodiment, a pulling method or a covering method of this invention is used for an application selected from but not limited to: protecting fruit on fruit-trees from birds and/or from insects/pests, protecting a surface/object from sun/rain/wind/moisture, protecting a liquid reservoir from liquid evaporation, camouflage a military assembly, mark a region or an area for spraying, planting, seeding, mark an area for airplane landing, mark an area for landscaping, mark a no-entry region, defining borders of a geographical/farming area, protecting a seeded area from pests/insects, protecting a crop region from pests/insects, selective seeding or planting in portions of a field, selective irrigation of portions of a field, protecting a building or a portion thereof during renovation, decorating a building, generating a roof for a building/structure, generating walls for a building/structure, or any combination thereof. Many other applications of covering methods of this invention are possible and are included in this invention. In one embodiment, a pulling method of this invention is used for delivering supplies to a disaster area. In one embodiment, a pulling method of this invention is used for delivering supplies to a distant/remote, hardly-accessible, or non-accessible area. According to this aspect and in one embodiment, a method of this invention comprises transfer of an electrical cord/line to such an area as described herein above. In one embodiment, electrical power can be supplied to such an area using a method of this invention as described herein above. According to this aspect and in one embodiment, a method of this invention comprises transfer of a water hose to such an area as described herein above. According to this aspect and in one embodiment, water can be supplied to such an area. According to this aspect and in one embodiment, a method of this invention comprises transfer of a liquid/gas hose to such an area as described herein above. According to this aspect and in one embodiment, gas or liquid can be supplied to such an area. For example and in one embodiment, such delivered gas is selected from: air, oxygen, helium, argon, nitrogen, or any combination thereof. In one embodiment, any other gas can be transferred by a hose that has been pulled to a distant/disaster area. For example and in one embodiment, such delivered liquid is selected from water, disinfecting solution, saline, medication, aqueous solution, non-aqueous solution, alcohol, fuel, or any other liquid that can be transferred by a hose that has been pulled to a distant/disaster area.

In one embodiment, methods of this invention are used for transferring water or other liquids to a remote or to an otherwise inaccessible area. In one embodiment, methods of this invention are used for transferring solids such as drugs or medical materials, first aid in a tube/hose that is pulled by methods of this invention. In one embodiment, a vacuum/pressure/gravitational system enables, facilitates, or assists the transfer of solids through such tube/hose. In one embodiment, solids transferred through such hoses/tubes may comprise food, nutrients, food for humans, food for animals, food for birds, rescue materials, essential materials, for stranded humans/animals etc.

In one embodiment, the elongated element comprises flexible solar cells. According to this aspect and in one embodiment, methods of this invention comprise covering an area with a flexible elongated element comprising solar cells. According to this aspect and in one embodiment, methods of this invention comprise pulling flexible elongated element comprising solar cells over an area for harnessing solar power. According to this aspect and in one embodiment, the elongated element comprises electrical wires. According to this aspect and in one embodiment, the flexible solar panels/cells are configured into an elongated element that is capable of being rolled on a roller.

In one embodiment, methods of this invention are used to stretch a wire for remote operation of a device/system. In one embodiment, methods of this invention are used for lighting. For example, an elongated element comprising lighting elements such as lamps is pulled over an area that needs lighting (e.g. a construction area, a disaster area, recreational area etc.). In one embodiment, methods of this invention are used to transfer a rope to stranded humans or animals for rescue. In one embodiment, according to methods of this invention, a water hose is lowered into a water reservoir in order to withdraw water from the reservoir. Such withdrawal may be done using a pump and optionally by siphon action. In one embodiment, methods of this invention are used to transfer a cable. In one embodiment, the cable is used to transfer an additional heavier cable by other means. In one embodiment, methods of this invention are used for laying a communication cable. In one embodiment, the roller is referred to as a dispenser. In one embodiment, a dispenser of an elongated element is mounted on a drone instead of a roller. In one embodiment, the roller is a dispenser and vice versa. In one embodiment, methods of this invention are used for laying irrigation tubes in fields, next to crops, over crops, over trees etc. In one embodiment, methods of this invention are used for laying spraying/fertilizers tubes in fields, next to crops, over crops, over trees etc. In one embodiment, methods of this invention are used to transfer elongated elements over cliffs, mountains, rivers, or any portion thereof.

In one embodiment, methods of this invention are used to rescue animals. In one embodiment, methods of this invention are used for animal's safety. In one embodiment, methods of this invention are used to capture, to accumulate, to gather animals for their rescue or for safety. In one embodiment, methods of this invention are used to restrict animals to a certain area such as a certain farming area. In one embodiment, methods of this invention are used to restrict animals to a certain area to prevent them from entering dangerous or unsafe areas. According to this aspect and in one embodiment, the elongated element (e.g. when wrapped on a series of poles) defines a border or a fence for the animals, for example next to a slippery/muddy area, next to a cliff etc.

In one embodiment, systems and methods of this invention are used to transfer an elongated element through water. According to this aspect and in one embodiment, the elongated element is selected from a tube, a hose, a wire, a cable, a cord, or any combination thereof.

In one embodiment, the drone is an underwater unmanned vehicle. According to this aspect and in one embodiment, the underwater unmanned vehicle carries a cord, a cable, a wire, a hose, or a tube. According to this aspect and in one embodiment, the drone carries a tube to a submarine. In one embodiment, the drone delivers oxygen to the submarine and/or to submarine personnel. In one embodiment, the drone delivers electricity, power, water, liquids, gases to the submarine. According to this aspect and in one embodiment, the unmanned underwater vehicle comprises a roller as described herein above and is used for the rescue of people stranded in a submarine or in any other underwater area/vessel. In one embodiment, the underwater unmanned vehicle is an underwater vehicle, or an underwater drone. In one embodiment, the drone is an unmanned underwater vehicle (UUV). In one embodiment, the drone is an underwater drone. In one embodiment, the underwater vehicles are remotely operated underwater vehicles (ROUVs). In one embodiment, the underwater vehicles are autonomous underwater vehicles (AUVs). ROUVs are remotely controlled by a human operator. AUVs are automated and operate independently of direct human input.

Remotely operated underwater vehicle: remotely operated underwater vehicles (ROUVs) are a subclass of UUVs. ROUVs are manually remotely controlled by an operator to perform tasks. In one embodiment, the ROUV comprises elements selected from: a camera, actuators, sensors, motor, or any combination thereof.

Autonomous underwater vehicle: autonomous underwater vehicles (AUVs) are defined as underwater vehicles that can operate without a human operator.

All such underwater unmanned vehicles are included in embodiments of this invention and are sometimes referred to in general as drones.

In some embodiments, the above-mentioned classification of remotely-operated and autonomous is also applicable to aerial drones of this invention. Some embodiments described herein with reference to a drone in general, are applicable to autonomous drones and to remotely-operated drones and are included in this invention. Some embodiments described herein with reference to a drone in general, are applicable to autonomous underwater drones and to remotely-operated underwater drones and are included in this invention. In some embodiments, for autonomous aerial or underwater drones, a control system or a drone-control device is not required or is only used for short period of times from the overall operation time of the drone. Accordingly and in some embodiments, embodiments described herein that include a drone-control device are applicable to systems that do not comprise a drone-control device and all such embodiments are included in this invention. In one embodiment, methods of this invention are not used for fishing. In one embodiment, methods of this invention are not used for fishing using a fishing rod. In one embodiment, methods of this invention are used for fishing. In one embodiment, methods of this invention are used for fishing using a fishing rod. In one embodiment, methods of this invention are used for covering a fishing pond. In one embodiment, methods of this invention are used for covering a fishing farm. In one embodiment, methods of this invention are used for covering a water reservoir comprising fish. According to this aspect and in one embodiment, covering a reservoir comprising fish, protects the fish from birds. According to this aspect and in one embodiment, covering a reservoir comprising fish, protects the fish from being eaten by birds.

### Embodiments of Systems and Methods of the Invention

FIG. 1 depicts one embodiment of a system of this invention. The system comprises at least one drone (100), an elongated element (110) and a controlling apparatus (a drone-control device (130)). The drone comprises a contact element such as a roller (not shown in this figure) configured to connect the drone to the elongated element. FIG. 1 provides an example showing how a system of this invention is used to cover a line of trees. The rolled covering element (110) is mounted on at least one drone using a roller and optionally connection elements/points on the drone and on the roller. An exposed end of the covering element is secured to an external fixture/structure (140). The drone is then moved in a direction suitable to cover a line of trees (120). As the drone moves, it pulls the covering element, thus covering the line of trees. The control apparatus (130) controls the movement of the drone. Direction, elevation, angle, and speed of the drone are monitored by the control apparatus (device). When the series of objects is covered, the drone movement can be halted, and it can be lowered to the ground or brought to landing on a pre-fixed mount.

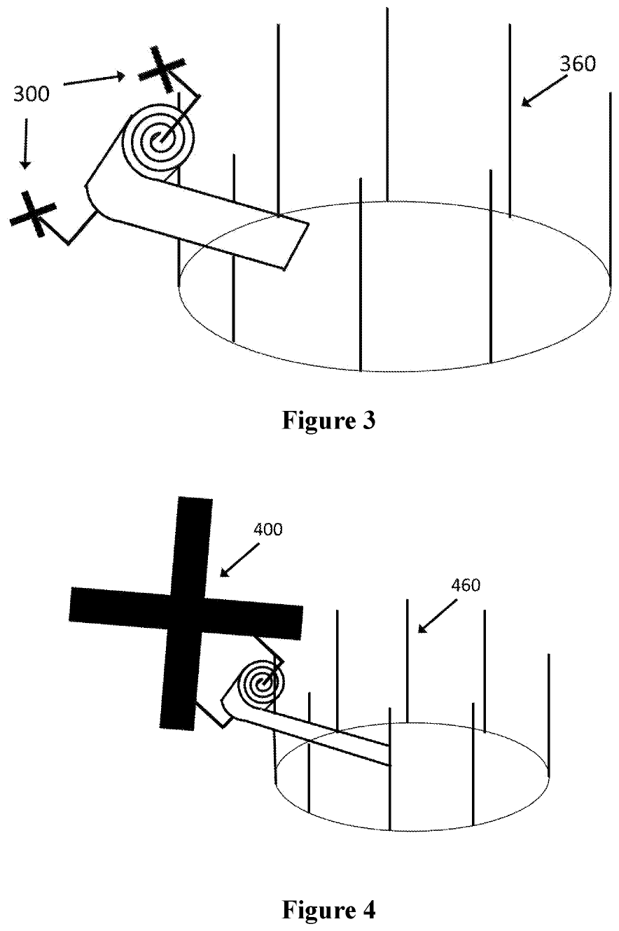

FIGS. 2A-2B illustrate two examples of attachments of an exposed end of a covering element to an external anchor point. The figures show two embodiments of anchor points (connection points/elements) on an exposed end of a covering element, configured to be connected to an anchor point/region external to the drone; FIG. 2A shows one anchor point (circle 250) located at, or proximal to, an exposed end of a covering element (210); FIG. 2B shows two anchor points (250) located at, or proximal to, an exposed end of a covering element (210);

FIG. 2A shows a sheet of an elongated element that can be attached to an anchor point in one point/corner. FIG. 2B shows a sheet of covering/elongated element that can be attached to an anchor point/region at two corners (or at regions proximal to two corners). The drone(s) thus shifts the rolled sheet to cover an object/surface, while the exposed end of the sheet/stripe is fastened to an external anchor point/region, to allow pulling and covering by the drone. It is to be noted that the attachment of the end of the elongated element to an external anchor point/region is not limited to one or two anchor points. Such an attachment can be attachment of a line on the elongated element, a patch, or an area on the elongated element, more than two points or more than two regions on the elongated element. Similarly, any such area/region, line/patch/point/points on the external anchor can be used to attach the elongated element to the external anchor. It is to be noted that the shape of the elongated sheet is not limited. Any elongated sheet shape can be used. For example, any elongated shape that comprises quadrangles, squares, rectangles, triangles, parallelograms, diamonds shapes, circles, ovals, random shapes, arbitrary shapes, smooth-edge shapes, serrated edge shapes, symmetric shapes, non-symmetric shapes, zig-zag shapes, partially symmetric shapes etc. can be used in embodiments of this invention. The elongated shape may comprise a stripe, a sheet, a long stripe, a long sheet, a random elongated shape, an arbitrary elongated shape, a smooth-edge shape, a serrated edge shape, a shape comprising perforated edge, a zig-zag elongated shape, a symmetric shape, a non-symmetric shape, a partially symmetric shape etc.

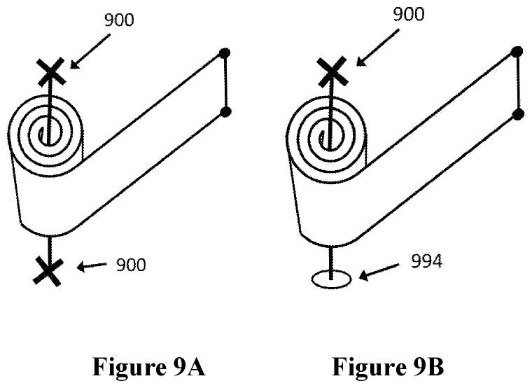

In one embodiment, methods of this invention comprise covering (or wrapping) the sides of a structure (or an object) as illustrated for example in FIG. 3. According to this aspect and in one embodiment, an exposed end of a rolled/folded covering element is attached to a side of the object/structure, or to an anchor point in proximity to the object/structure. A rolled covering element is attached to a drone. The drone comprises a roller (or any similar feature) on which the covering element is rolled. The drone pulls the covering element around the object or around a portion thereof. The attachment of the exposed end of the covering element to a point external to the drone, allows the covering element to roll-off the roller and cover the sides of the required structure. The width of the covering element may be adjusted to fit the sides of the object to be covered or any portion thereof. In one embodiment, for example, where the drone pulls the covering element for the purpose of e.g. marking, the width of the covering element may be a width of a stripe. In one embodiment, the covering element may be of a small width such that it forms a stripe. A stripe can be used to cover sides of an object for marking that object as further detailed herein. In one embodiment, the rolled covering element is mounted on a vertical roller, i.e. the long dimension of the roller extends vertically down from the drone (see for example FIG. 9). In one embodiment, the roller is mounted between (or adjacent to) two drones such that the long dimension of the roller is vertical with respect to the ground or to a basis of a structure to be covered. For example, FIG. 9A illustrates a roller mounted vertically between two drones. FIG. 9B illustrates an example of a roller mounted vertically beneath a drone. A stopper 994 may be fixed underneath the roller in some embodiments.

In one embodiment, a folded covering element is dispensed from a dispenser that is mounted on the drone. In one embodiment, in addition to a roller onto which the covering element is wrapped, the covering element is disposed from between two additional parallel rollers. The additional parallel rollers control the withdrawal of a rolled covering element such that it is dispensed from a slit formed between the two parallel rollers.

In one embodiment, such covering method as described herein above, is applicable to cover a structure, a construction, a ship, a lot, a fenced area, or any other object that requires a covering, that requires a wrap, which requires a marking or any sort of protection. In one embodiment, the rolled covering element is placed outside the structure. In one embodiment, the covering element is placed inside the structure and is secured to the structure by connection elements. In one embodiment, the covering element is placed such that one portion of it is outside the structure and another portion of it is inside the structure/object to be covered. According to this aspect and in one embodiment, there is a set of poles defining a structure and the drone pulls the covering element such that it surrounds a first pole from one side of the structure (side of a central line as defined by the set of poles) and it surrounds the next pole from the another side of the structure (another side of a central line as defined by the set of poles). One example for this embodiment, is a long linear set of poles wherein the covering element is assembled alternately between the poles (wrapping one pole from one side and the next pole from the other side with respect to the line of poles, and repeating this alternating coverage). According to this aspect and in one embodiment, such coverage provides better stability, for example under windy conditions.

In one embodiment, covering the object refers to surrounding the object or a portion thereof. In all such side coverings, connections elements on the covering element can be used to fasten the covering element to the poles, to the ground, to a top structure or to any other anchor on or proximal to the structure. FIG. 4 illustrates one drone pulling a stripe around the sides of a structure as described herein above.

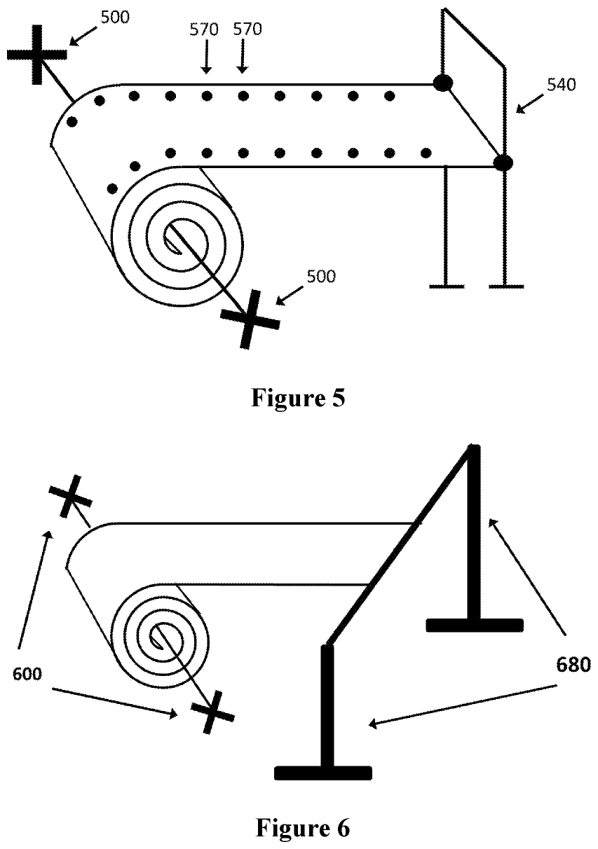

FIG. 5 illustrates an embodiment where the sides of a rolled covering element comprise a series of anchor points (570). The anchor points may be used to fasten the covering element around an object to be covered or fasten it onto a surface. For example, when the covering element covers a line of crops in a field, the sides of the covering element may be connected to the ground on both sides of the covered crop-line. In one embodiment, where the covering element covers a surface of a field/ground, or a water-channel, the anchor points on the side of the covering element are used to secure the covering to the ground or to any other feature on at least one, or on both sides, of the surface that is covered. In one embodiment, for example where an elongated surface of a field is covered by methods of this invention (e.g., after seeding and prior to germination/sprouting), the anchor points on the sides of the covering element are secured to the ground using a peg, a rod, a U-shaped rod etc. Such anchor points on a side of a covering element may comprise any feature as detailed herein for the connection elements. For example, the anchor points on the side of a sheet may comprise holes, loops, rings, Velcro® attachments, protrusions etc.

In one embodiment, a sheet covering the top and optionally portions of the side(s) of a structure comprises anchor points on its side(s). Such anchor points are used to secure the sides of the covering element to the sides of the structure, to the ground or to any other feature that helps to fasten the covering element to the object/surface that is covered.

In one embodiment, a rolled covering element is mounted on a roller connected to at least one drone as described herein. In one embodiment, as shown in FIG. 6, an exposed end of the covering element is connected to a stand (680). In one embodiment, the stand (680) elevates the roller and the rolled covering element. In one embodiment, such a stand facilitates withdrawal of the rolled covering element from the roll. In one embodiment, such stand elevates the covering element such that when it is pulled from the drone, the covering of a lower object/surface is facilitated. The shape and form of the stand/mount/structure connected to the exposed end of the covering element is not limited and can be of any form/shape as known in the art for fixing/holding/connecting exposed ends of stripes/cords or sheets. In one embodiment, such a stand enables to cover lower surfaces or lines of objects without the need to initially pull the covering element up. In one embodiment, the height of the stand may be adjusted to fit any object(s) or surface(s) to be covered. According to this aspect and in one embodiment, the ‘legs’ (or supporting structure elements) of the mounting stand are telescopic arms/telescopic structures.

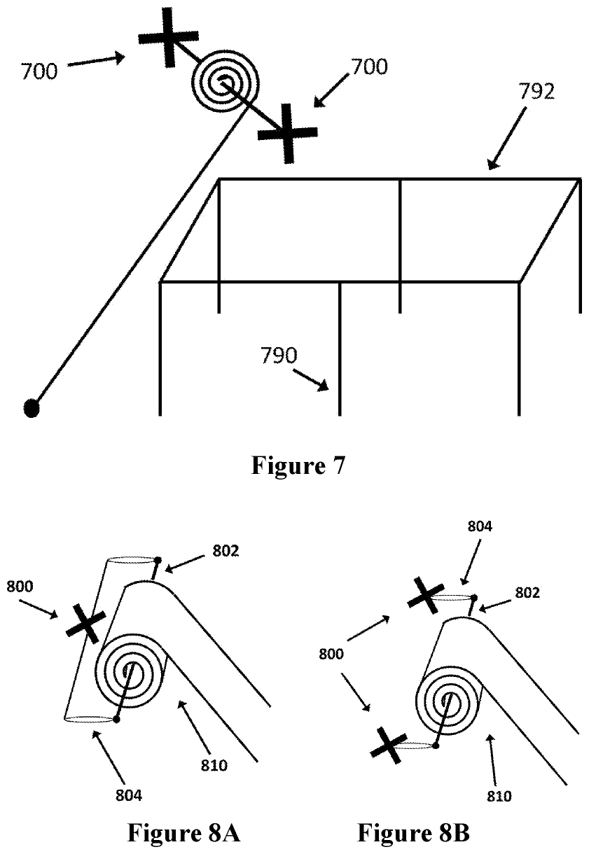

In one embodiment, methods of this invention are used to pull a covering element using at least one drone to cover the top of a structure and optionally its sides (see for example FIG. 7). As illustrated in FIG. 7, a structure comprises a set of poles (790) and a top construction of beams (792) provides an example of an object to be covered. According to this aspect and in one embodiment, the drone(s) pulls the rolled covering element up above the height of the structure. Securing the exposed edge of the covering element e.g. to the ground enables to dispense a portion of the covering element from the roller on the drone. The drone then directs the covering element over the top of the structure and optionally around its opposite side. In one embodiment, use of a stand as shown in FIG. 6, allows the drone to pull the covering element horizontally from one side of the structure to the opposing side. In one embodiment, when the rolled covering element is placed close to the ground, the drone pulls it up to a height that is measured to include both the height of the structure and the length of the top to be covered. According to this aspect and in one embodiment, the drone then directs the covering element over the top of the structure. In one embodiment, such movement eliminates or reduces friction between the covering element and the top side of the structure closest to the rolled element. In another embodiment, the drone pulls the covering element just above the height of the structure, and then moves to the opposite side on top of the structure. In one embodiment, such covering is possible where the top beam does not generate substantial obstacle to the movement of the covering element on it. In one embodiment, another roller is mounted on one or more of the top beams to facilitate movement of the covering element over the top beams. In one embodiment, one or more of the top beams are or comprise a roller(s). In one embodiment, covering the top and the sides of a structure is performed in two steps: the first step covers the top of the structure and two opposing sides, according to a direction as illustrated in FIG. 7. In a second step the two opposing not-yet-covered sides are covered, while the top of the structure is covered again by a second layer of a covering element. In some embodiments, wherein the object/structure to be covered is not a quadrangle, any number of steps for covering more than two opposing sides of the structure can be used. All such steps are included in this invention. In one embodiment, the top construction of beam may include more than two or more than three or more than four beams. Top beams may be placed not just on the sides of the structure but also in any region that is included in the top frame of the structure.

FIG. 8A illustrates one drone (800) comprising a roller (802), the roller is connected at two points to the drone; a connection element (804) connects the roller to the drone. In one embodiment, the roller is made of a material selected from: wood, a metal/metal alloy, organic polymer, inorganic polymer, or any combination thereof. In one embodiment, the roller is made of a light-weight material. In one embodiment, the roller is made of light-weight wood material, light-weight metal/metal alloy, light weight organic polymer, light weight inorganic polymer or any combination thereof. In one embodiment, the roller is made of or comprises a material selected from: aluminum, titanium, balsa, low-density polyethylene (LDPE), high-density polyethylene (HDPE), polypropylene (PP), Polyvinyl chloride (PVC), Polyethylene terephthalate (PET), Polyurethane, PPA, or any combination thereof. The connection (804) can be any of the connection element(s) or anchors as detailed herein or any combination thereof. The connection may be an arm connecting the roller to the drone. The connection element can be any element as described herein that provides attachment of the roller to the drone. In one embodiment, a supporting arm connects the roller to the drone. In one embodiment, the supporting arm is considered a portion of the drone. In one embodiment, the drone comprises a supporting arm(s). In one embodiment, a first connection element on the drone (or on a drone's arm) is an element that complements a second connection element on the roller. It is to be noted that any element(s) that enable(s) to connect two objects as known in the art can be used to connect the drone or a drone's arm(s) to the roller in embodiments of this invention.

In one embodiment, a drone lifts/shifts the covering element over an object to be covered. In one embodiment, the object may be a tree, a pole, a telecommunication pole, a streetlight, a solar panel, a street mirror, etc. In one embodiment, the drone lowers the covering element over the object, thus covering the object. In one embodiment, following coverage of an object/surface as desired, the exposed end of the covering (elongated) element is disengaged from the drone, e.g. by manual cutting, and the drone moves away from the disengaged portion of the covering element. Such method of covering may be utilized to protect objects from sun/rain/wind/moisture/hail/snow/dry conditions. Such method of covering may be utilized to protect trees/bushes/crops from sun/rain/wind/moisture/hail/snow/dry conditions and/or from birds, insects, pests who may harm the plant, the crop, the fruit, the vegetable, the flowers of, the buds, the seeds, the leaves, the bark or any other component of the tree/bush/crop to be protected. According to this aspect and in one embodiment, when protection is no longer necessary, the drone comprising a roller may be directed back to the covering element, engages with one end of it and lifts/shifts/remove the covering element by rolling on the roller, pulling it away from the object, thus leaving the object exposed, for example as it was before it was covered.

a Surface, an Object, or a Surface of an Object Covered by Methods of this Invention

In one embodiment, this invention provides a method of covering a surface. The surface to be covered by methods of this invention is not limited. For example, the surface can be a field, an orchard, a water reservoir, a road, a warehouse, a lot, a nature/outdoor area, or any surface as noted herein above. In one embodiment the surface to be covered is a surface of a field or any portion thereof, a tree, a crop, a line of trees, a line of crops, an orchard, a bush, a line of bushes, a field of bushes, a building, a line of buildings, a region of buildings, a geographical area, a mountain, a cliff, a river, a logistical area, a water reservoir, a liquid reservoir, a fish pond, an agricultural fish farm, a water channel, a liquid channel, a car lot, a garage, a truck lot, a road, a street, a forest, an army unit, an army base, a supply camp, an assembly area, a gathering area, a storage area, a territory, a piece of land, an area, a lot, a yard, a warehouse, a side of a building, a portion of a ground, a balcony, or any portion or any combination thereof. In one embodiment, the surface to be covered is selected from a list consisting of the items described in the list herein above. In one embodiment, for covering a water reservoir, the covering element is made of a material that can float over the water. If the reservoir comprises a solution such as salt-water solution, the covering element is made of a material that can float over that solution. For covering a reservoir comprising a non-aqueous liquid, the covering element is made of a material that can float over that liquid. In one embodiment, an animal or a group of animals is/are covered by methods of this invention. Any other surface or object may be covered by methods of this invention.

### Multiple Systems/Parallel Operation

In one embodiment, multiple systems of this invention are employed. In one embodiment, multiple systems are used to cover adjacent areas at the same time. In one embodiment, multiple covering elements of this invention are employed. In one embodiment, multiple covering elements are used to cover adjacent areas at the same time. For example and in one embodiment, two or more lines of trees in an orchard are covered simultaneously using two or more covering elements each placed next to one line of trees. In one embodiment, different drones pull the different covering elements such that each covering element covers a different line of trees. According to this aspect and in one embodiment, covering all the trees in an orchard is performed much faster, as drones pull two or more covering elements at the same time, or at least partially at the same time. In one embodiment, such action is faster than what it would be if only one system, or one covering element had been used sequentially on the separate lines of trees. Such parallel pulling/transferring of two or more covering elements, is not limited to covering trees and is applicable to any other application where covering/marking multiple lines/regions is required. Such parallel pulling/transferring of two or more elongated elements, is not limited and is applicable to any other application where transferring multiple lines, cords, cables, wires, hoses, or tubes is required.

### Methods of Marking

In one embodiment, methods of this invention comprise methods or marking an area. According to this aspect and in one embodiment, the elongated element is in the form of an elongated stripe. In one embodiment, a drone pulls a rolled stripe, the exposed end of the stripe is attached to an external anchor. In one embodiment, the drone dispenses portions of the stripe as it moves, in order to mark a line or an area. In one embodiment, a drone pulls a folded/rolled stripe to extend it over a surface to be marked. In one embodiment of this invention, a method of covering a surface is a method of marking a surface. In some embodiment, marking methods of this invention are used for marking a non-entry area using a stripe. In one embodiment, marking methods of this invention are used to designate an area to be treated or to be tested. In some embodiment, marking methods of this invention are used to designate an area to be populated, to designate an area for construction, for spraying, for seeding, for irrigating, for subsequent covering, for bordering etc. In one embodiment, methods of marking an area comprise covering an area by a sheet. In one embodiment, methods of marking an area comprise marking the circumference, the sides or any portion or combination thereof using stripes and/or sheets pulled by a drone as noted herein above. In one embodiment, the elongated element comprises light sources and electrical wires, and it is used to mark an area by illuminating light. In one embodiment, such marking is utilized for visibility at night or visibility under reduced-light conditions.

Systems of this Invention

In one embodiment, this invention provides a system for pulling an elongated object, said system comprising:
at least one drone;
a roller connected to said drone;
an elongated element comprising a first end and a second end, said element is wrapped around said roller;
a drone-control device;
wherein said first end of said elongated element is connected to said roller;
   wherein said second end of said elongated element is configured to be connected to an external anchor point/region located on an object external to said drone;
   wherein when said elongated element is connected to said anchor point/region, and when said drone is moving, the drone is capable of pulling said elongated element over at least one surface, at least one object or a combination thereof, and wherein at least a portion of the drone's movement is a non-vertical movement.

In one embodiment, this invention provides a system for pulling an elongated object, said system comprising:
at least one drone;
a roller connected to said drone;
an elongated element comprising a first end and a second end, said element is wrapped around said roller;
a drone-control device;
wherein said first end of said elongated element is connected to said roller;
   wherein said second end of said elongated element is configured to be connected to an external anchor point/region located on an object external to said drone;
   wherein when said elongated element is connected to said anchor point/region, and when said drone is moving, the drone is capable of pulling said elongated element over at least one surface, at least one object or a combination thereof.

In one embodiment, this invention provides a system for covering at least one surface, at least one object or a combination thereof, said system comprising:
at least one drone;
a roller connected to said drone;
an elongated element comprising a first end and a second end, said element is wrapped around said roller;
a drone-control device;
wherein the first end of the elongated element is connected to the roller;
   wherein said second end of said elongated element is configured to be connected to an external anchor point/region located on an object external to said drone;
   wherein when said elongated element is connected to said external anchor point/region, and when said drone is moving, the drone is capable of pulling said elongated element over at least one surface, at least one object or a combination thereof, and wherein at least a portion of the drone's movement is a non-vertical movement.

In one embodiment, this invention provides a system for covering at least one surface, at least one object or a combination thereof, said system comprising:
at least one drone;
a roller connected to said drone;
an elongated element comprising a first end and a second end, said element is wrapped around said roller;
a drone-control device;
wherein the first end of the elongated element is connected to the roller;
   wherein said second end of said elongated element is configured to be connected to an external anchor point/region located on an object external to said drone;
   wherein when said elongated element is connected to said external anchor point/region, and when said drone is moving, the drone is capable of pulling said elongated element over at least one surface, at least one object or a combination thereof.

In one embodiment, this invention provides a system for covering at least one surface, at least one object or a combination thereof, said system comprising:
at least one drone comprising a first connection element;
a covering element comprising a second connection element;
optionally a drone-control device;
wherein said first connection element is configured to be connected to said second connection element thus connecting said drone to said covering element; wherein when the drone is connected to the covering element, the drone is capable of pulling the covering element over said at least one surface, at least one object or a combination thereof, thus covering said at least one surface, at least one object or a combination thereof.

In one embodiment, the system further comprising a third connection element configured to be connected to the at least one drone and to the covering element, thus connecting the drone to the covering element.

In one embodiment, this invention provides a system for covering at least one surface, at least one object or a combination thereof, said system comprising:
at least one drone comprising a roller;
a covering element wrapped around said roller;
optionally a drone-control device;
wherein a portion of said elongated element is configured to be connected to an anchor external to said drone; wherein when the covering element is connected to said anchor, the drone is capable of pulling the covering element over said at least one surface, said at least one object or a combination thereof, thus covering and/or marking said at least one surface, at least one object or a combination thereof.

In one embodiment, this invention provides a system for transferring an elongated element over at least one surface, over at least one object or a combination thereof, said system comprising:
at least one drone comprising a roller;
an elongated element wrapped around said roller;
optionally a drone-control device;
wherein a portion of said elongated element is configured to be connected to an anchor external to said drone; wherein when the elongated element is connected to said anchor, the drone is capable of pulling the covering element over said at least one surface, over said at least one object or a combination thereof, thus transferring said elongated element over said at least one surface, over said at least one object or a combination thereof.

In one embodiment, the second end of said elongated element, said external anchor point/region or a combination thereof comprises a connection element, a connection point, an anchor point, an anchor element, a connection/anchor region, or any combination thereof. In one embodiment, the system further comprising a bifunctional connection element configured to be connected to:
said second end of said elongated element; and to
said external anchor point/region;
thus connecting said elongated element to said external anchor point/region.

In one embodiment, the second end of said elongated element, said external anchor point/region, said bifunctional connection element or any combination thereof comprises a hook, a magnet, a button, a loop, a hole, a fastener, a Velcro® attachment, a rope, a string, a cord, a stripe, a thread, a zipper, a chain, a ring, a tape, a sticky tape, a vacuum element, a crocodile clip, a clip, a belt, a closure, an arm, a bolt, a nail, a nut, a pole a rod, a depression, an indentation, a protrusion, a bump, a bulge, a link, a lock, a holder, a hollow channel or any portion or combination thereof.

In one embodiment, the elongated element comprises a sheet, a cord, a stripe, a hose, a tube, a wire, a string, a thread, a chain, a rope, a conduit, a web, a fabric, a blanket, a woven material, a foil, a net, a sponge, a plastic sheet, a cloth, a paper, or any combination thereof. In one embodiment, the elongated element is made of a material comprising a polymer. In one embodiment, the polymer is organic, inorganic or any combination thereof. In one embodiment, the material further comprises a metal, an alloy, small molecules, or any combination thereof.

In one embodiment, the length of said elongated element ranges between 1 m-10 m, or between 1 m-100 m, or between 1 m-1000 m, or between 1 m and 10,000 m.

In one embodiment, the width of said elongated element ranges between 0.0001 m-1 m, or between 0.001 m-1 m, or between 0.001 m-0.1 m, or between 0.01 m-1 m, or between 0.1 m-1 m, or between 0.1 m-10 m, or between 1 m-10 m, or between 1 m-100 m, or between 1 m-500 m, or between 0.001 m-100 m, or between 0.05 m-100 m.

In one embodiment, the thickness of said elongated element ranges between 10 μm-100 μm, or between 100 μm and 1 mm, or between 1 mm and 1 cm or between 1 cm and 10 cm, or between 10 μm-20 cm. In one embodiment, the thickness of said elongated element ranges between 10 μm-2 cm. In one embodiment, the elongated element has a circular or an oval cross-section, and wherein at least one dimension of said cross-section ranges between 10 μm-100 μm, or between 100 μm and 1 mm, or between 1 mm and 1 cm or between 1 cm and 10 cm, or between 10 μm-20 cm. In one embodiment, at least one dimension of said cross-section ranges between 10 μm-5 cm. In one embodiment, the drone is capable of pulling at least 0.5 kg, or at least 6 kg, or at least 10 kg. In one embodiment, the drone is capable of pulling at least 20 kg.

In one embodiment, the elongated element is in the form of a sheet, and wherein the weight of said sheet is at least 10 g per 1 m² of sheet area, or between 20 g-120 g per 1 m² of sheet area, or between 50 g and 1000 g per 1 m² of sheet area.

In one embodiment, the elongated element or a portion thereof is waterproof. In one embodiment, the elongated element comprises two or more layers. In one embodiment, the elongated element or a portion thereof is transparent. In one embodiment, the elongated element is at least partially luminescent, at least partially IR reflective, at least partially reflective of visible light, at least partially UV reflective or any combination thereof. In one embodiment, the elongated element absorbs at least a portion of the radiation at the IR range, absorbs at least a portion of the radiation at the visible light range, absorbs at least a portion of the radiation at the UV range or any combination thereof. In one embodiment, the elongated element transfers at least a portion of the radiation at the IR range, transfers at least a portion of the radiation at the visible light range, transfers at least a portion of the radiation at the UV range or any combination thereof.

In one embodiment, the elongated element comprises at least one of: electrical wire(s), electrical cord(s), electrical element(s), electrical component(s), a connection to a power supply/current generator, or any combination or any number thereof. In one embodiment, the elongated element comprises at least one light source such as a light emitting diode (LED), a lamp or any combination thereof, wherein said elongated element is configured to illuminate when connected to a power supply. In one embodiment, the elongated element comprises at least one light source. In one embodiment, the light source is selected from a light emitting diode (LED), a lamp, or a combination thereof. In one embodiment, the light source is a luminescent light source. In one embodiment, the luminescent light source is a ‘stick light’. In one embodiment, the light source is a solar light source. In one embodiment, a series of light sources is configured/placed along the length of an elongated element. In one embodiment, the elongated element is configured to illuminate when a light source is connected to a power supply. In one embodiment, the elongated element is configured to illuminate when a light source is turned on.

In one embodiment, the elongated element comprises a sheet, a web, a fabric, a blanket, a woven material, a foil, a net, a plastic sheet, a cloth, a paper, or any combination thereof. In one embodiment, the material of said covering element comprises a polymer. In one embodiment, the polymer is organic, inorganic or any combination thereof. In one embodiment, the material of said covering element further comprises a metal, an alloy, small molecules, or any combination thereof.

In one embodiment, the elongated element comprises a power supply. In one embodiment, the elongated element comprises solar cell(s).

In one embodiment, more than one system is used. According to this aspect and in one embodiment, multiple systems of this invention are used at the same time or sequentially, or at least partially in parallel, to cover different portions of a surface, or of an object or of a combination thereof.

In one embodiment, systems of this invention comprise a release mechanism. A release mechanism can be triggered to release a load or release an object. A release mechanism can be operated to release any object attached to the drone. For example and in one embodiment, a release mechanism attached to a drone of this invention is used to release a roller, or to release (or disconnect from) a certain portion of an elongated element. In one embodiment, a release mechanism is used to disconnect an end of an elongated element from the drone. In one embodiment, a release mechanism is used to disconnect an end of an elongated element from the roller. Any release mechanism known in the art may be used in systems and methods of this invention. Any release mechanism known in the art may be used in/on drones of this invention.

Drones of this Invention

In one embodiment, drones of this invention comprise any drone capable of carrying a weight. In one embodiment, drones of this invention are remotely operated as known in the art. In one embodiment, the drone comprises 4-8 propellers. In one embodiment, the drone comprises 4 propellers. In one embodiment, the drone comprises 6 propellers. In one embodiment, the drone comprises 8 propellers. In one embodiment, the drone comprises more than 8 propellers. In one embodiment, the drone comprises at least one wing. In one embodiment, the drone comprises a combination of propellers and at least one wing. In one embodiment, the propellers are primarily used for taking-off and landing and partially for non-vertical flight, while the wing is used primarily for gliding. In one embodiment, the term drone comprises any unmanned air vehicle (UAV). In another embodiment, the term drone comprises UAV's that do not comprise gliding wings. In another embodiment, the term drone comprises UAV's that comprise propellers but do not comprise gliding wings. In one embodiment, the weight of the drone is less than 2000 kg. In one embodiment, the drone's weight is less than 100 kg. In one embodiment, the weight of the drone is less than 25 kg. In one embodiment, the drone or the UAV of this invention is capable of carrying a weight of up to 8 kg, or up to 10 kg, or up to 50 kg or up to 100 kg. In one embodiment, the drone or UAV of this invention is capable of carrying a weight of up to 1000 kg or up to 2000 kg. In one embodiment, drones of this invention comprise elements selected from: a frame, a skeleton, propellers, a battery, a camera, sensors, actuators, a global positioning system (GPS), flight controller, gyroscope, compass, altitude sensors, height sensors, velocity sensors, obstacle sensors, motor(s), roller(s), optionally fixed-wing, or combinations thereof. In one embodiment, embodiments that are described herein for a drone, are applicable to two or more drones, to a fleet of drones, to two or more drones that are operated in parallel, to two or more drones that are operated in series, or any combination thereof. All such embodiments are included in this invention.

In one embodiment, drones of this invention carry a roller. In one embodiment, drones of this invention comprise a roller. In one embodiment, drones of this invention comprise a winch. In one embodiment, the roller may be attached and detached from the drone. According to this aspect and in one embodiment, a roller comprising an elongated element wrapped around it, can be mounted on the drone. Once the elongated element or any portion thereof is consumed (used), the roller can be detached from the drone, and a new roller comprising an elongated element can be mounted on the drone instead. In one embodiment, the roller comprising an elongated element is in the form of a cartridge that is inserted to the drone and that can be detached from the drone as needed.

In one embodiment, drones of this invention comprise propellers and fixed wing. According to this aspect and in one embodiment, take-off and landing is facilitated by the propellers, and flying is mainly facilitated by the wing(s). Such a combination saves energy and prolongs flight time in one embodiment. Such configuration saves battery energy in some embodiments. In some embodiments the drone's weight is less than 2000 kg. In some embodiments the drone's weight is less than 1000 kg. In some embodiments the drone's weight is less than 500 kg. In some embodiments the drone's weight is less than 100 kg. In some embodiments the drone's weight is less than 50 kg or less than 25 kg or less than 4 kg or less than 1 kg. In one embodiment, the drone's weight ranges between 100 g and 750 g.

In one embodiment, drones of this invention comprise a camera. In one embodiment, the drone comprises a meter gauge or a distance gauge. According to this aspect and in one embodiment, the drone comprises a gauge that measures the length of the elongated element that has been dispensed from the roller at a given point in time. In one embodiment, such gauge is connected to a processor that can exhibit the amount of elongated element length that is still available on the roller following partial dispensing of a portion of the elongated element. In one embodiment, a meter gauge or a distance gauge located on the drone, measures the length of a surface or of the object that has been covered by the elongated element at a given point in time. In one embodiment, such gauge is connected to a processor that can exhibit the length of the surface or of the object that has been covered by the elongated element at a certain point in time. According to this aspect and in one embodiment, a processor is used to compare the length of the surface already covered to the amount of elongated element length that is still available on the roller following partial dispensing of a portion of the elongated element.

In one embodiment, the length of the roller is larger than the largest dimension of the drone. In one embodiment, the length of the roller is smaller than the largest dimension of the drone. In one embodiment, the length of the roller is equivalent to, or is the same as, the largest dimension of the drone. In one embodiment, the roller is mounted on an arm wherein the length of the arm is longer than the largest dimension of the drone. According to this aspect and in one embodiment the arm is connected to the drone and the roller is connected to the arm. In one embodiment, the roller is mounted on an arm wherein the length of the arm is smaller than the largest dimension of the drone. According to this aspect and in one embodiment the arm is connected to the drone and the roller is connected to the arm. In one embodiment, the roller is mounted on an arm wherein the length of the arm is equivalent to, or is the same as, the largest dimension of the drone. According to this aspect and in one embodiment the arm is connected to the drone and the roller is connected to the arm.

Connection Elements of this Invention

In one embodiment, the connection element(s) comprises or consists of a connection point, anchor point or a connection region. In one embodiment, the connection element comprises a hook, a magnet, a button, a loop, a hole, a conduit, an anchor, a fastener, a Velcro® attachment, a rope, a string, a thread, a chain, a hook, a chain, a loop, a ring, a tape, a sticky tape, a vacuum element, a crocodile clip, a clip, a belt, a closure, an arm, a bolt, a nail, a fastener, a latch, a buckle, a clasp, a screw, a snap, a bolt, a lock, a staple, a nut, a button, a zipper, a pole, a rod, a depression, an indentation, a protrusion, a bump, a bulge, a link, a lock, a holder, a hollow channel or any portion or combination thereof.

In one embodiment, connection elements of this invention comprise any material known in the art. For example, and in one embodiment, connection elements of this invention comprise or consist of a material selected from a list consisting of metal, metal alloy, organic material, non-metal inorganic material or any combination thereof. In one embodiment, connection elements of this invention comprise a material selected from organic polymer, inorganic polymer, or any combination thereof. In one embodiment, the organic polymer further comprises small molecules, atoms, or any combination thereof. In one embodiment, the inorganic polymer further comprises small molecules, atoms, or any combination thereof.

In one embodiment, a connection element of this invention is a portion of the drone itself. For example, in one embodiment, an arm of the drone serves as a connection element onto which a roller is secured. In one embodiment, such arm or any other portion of the drone that serves as a connection element, is part of the frame or of the skeleton of the drone. In one embodiment, a roller of this invention is a portion of the drone itself. For example, in one embodiment, an arm of the drone serves as a roller. In one embodiment, an arm of the drone comprises a roller. In one embodiment, such an arm or any other portion of the drone that serves as or comprises a roller, is part of the frame or of the skeleton of the drone.

In one embodiment connection elements of this invention comprise:
a first connection element on a point/region external to the drone; and
a second connection element on a covering element.

In one embodiment, connection elements of this invention are used to connect the roller to the drone. In one embodiment, connection of the roller to the drone is reversible, i.e. the roller can be connected and disconnected from the drone.

In one embodiment, systems of this invention comprise a third connection element. According to this aspect and in one embodiment, the third connection element connects between the first and the second connection elements, such that the covering element is connected to external anchor. For example and in one embodiment, a first connection element is at least a portion of a mount/structure/feature that is external to the drone. A second connection is located on the covering element, and it comprises a hole placed in proximity to an edge of the covering element. A third connection element is for example a thread, a Velcro®, a loop, a ring or a clip designed to go through the hole of the covering element and around at least a portion of the external mount/structure/feature, thus connecting the covering element to the external anchor (mount/structure/feature). In one embodiment, wherein the elongated element is a rolled sheet or stripe, the roller comprises a length that spans the width of the rolled sheet, or spans a width that is similar to the width of the rolled sheet, or spans a width that is 5% to 20% longer or 1% to 40% longer than the width of the rolled sheet. In one embodiment, the length of the roller is the longest dimension of the roller. In one embodiment, the roller is connected to the drone at more than one point. For example, two corners (or regions close to the corners) of the roller are connected to two points (or to two regions) of the drone (see for example FIG. 8A). Connection element 804 in FIG. 8 may be or can be referred to as a first, a second or a third connection element, or any combination thereof. It is to be noted that connection element 804 in FIG. 8A and in FIG. 8B is a general illustration. Many other connection types, fixtures, cartridges, rollers, roller components, mounts, structures, elements, or any combination thereof can be used to attach the roller to the drone as known in the art. In one embodiment, the roller is fixed on a supporting arm of the drone. In one embodiment, the supporting arm is straight. In one embodiment, the supporting arm is curved. In one embodiment, the supporting arm is considered a connection element between the drone and the roller. In one embodiment, the supporting arm is, or comprises, the roller. In one embodiment, the supporting arm comprises at least one connection element. According to this aspect and in one embodiment, the supporting arm comprises any of the features described herein above for connection elements, or any portion or combination thereof, or any number thereof. In one embodiment, connection elements of this invention comprise, or are connected to, or are capable of being connected, to a carabiner.

Elongated Elements of this Invention

In one embodiment, the elongated element or the covering element comprises a sheet, a web, a fabric, a blanket, a woven material, a foil, a net, a porous material, or any combination thereof. In one embodiment, the elongated element comprises a perforated material. In one embodiment, the elongated/covering element comprises a homogeneous material. In one embodiment, the elongated element comprises a heterogeneous material. In one embodiment, the elongated element comprises more than one sheet. In one embodiment, at least two sheets comprising different materials or different composition are bonded to form the elongated element. In one embodiment, the material of said covering element comprises a polymer. In one embodiment, the polymer is organic, inorganic or any combination thereof. In one embodiment, the covering element is in the form of a foil, a fabric, a cloth, a paper, a plastic sheet, or any combination thereof. In one embodiment, the material of said covering element further comprises a metal, an alloy, small molecules, or any combination thereof. In one embodiment, the covering element is rolled, folded, flat, or any combination thereof. In one embodiment, the elongated element comprises a sheet, a cord, a stripe, a hose, a tube, a wire, a string, a thread, a chain, a rope, a conduit, a web, a fabric, a blanket, a woven material, a foil, a net, a sponge, a plastic sheet, a cloth, a paper, or any combination thereof. In one embodiment, the elongated element is made of a material comprising a polymer. In one embodiment, the polymer is organic, inorganic or any combination thereof. In one embodiment, the material further comprises a metal, an alloy, small molecules, or any combination thereof.

In one embodiment, the length of said elongated element ranges between 1 m-10 m, or between 1 m-100 m, or between 1 m-1000 m, or between 1 m and 10,000 m. In one embodiment, the width of said elongated element ranges between 0.0001 m-1 m, or between 0.001 m-1 m, or between 0.001 m-0.1 m, or between 0.01 m-1 m, or between 0.1 m-1 m, or between 0.1 m-10 m, or between 1 m-10 m, or between 1 m-100 m, or between 1 m-500 m, or between 0.001 m-100 m, or between 0.05 m-100 m. In one embodiment, the thickness of said elongated element ranges between 10 μm-100 μm, or between 100 μm and 1 mm, or between 1 mm and 1 cm or between 1 cm and 10 cm, or between 10 μm-20 cm. In one embodiment, the thickness of said elongated element ranges between 10 μm-2 cm. In one embodiment, the elongated element has a circular or an oval cross-section, and wherein at least one dimension of said cross-section ranges between 1 μm-10 μm, 10 μm-100 μm, or between 100 μm and 1 mm, or between 1 mm and 1 cm or between 1 cm and 10 cm, or between 10 μm-20 cm. In one embodiment, at least one dimension of said cross-section ranges between 10 μm-5 cm.

In one embodiment, the drone is capable of pulling at least 0.5 kg, or at least 6 kg, or at least 10 kg. In one embodiment, the drone is capable of pulling at least 20 kg.

In one embodiment, the elongated element is in the form of a sheet, and wherein the weight of said sheet is at least 10 g per 1 m² of sheet area, or between 20 g-120 g per 1 m² of sheet area, or between 50 g and 1000 g per 1 m² of sheet area.

In one embodiment, the elongated element or a portion thereof is waterproof. In one embodiment, the elongated element comprises two or more layers. In one embodiment, the elongated element or a portion thereof is transparent. In one embodiment, the elongated element is at least partially luminescent, at least partially IR reflective, at least partially reflective of visible light, at least partially UV reflective or any combination thereof. In one embodiment, the elongated element absorbs at least a portion of the radiation at the IR range, absorbs at least a portion of the radiation at the visible light range, absorbs at least a portion of the radiation at the UV range or any combination thereof. In one embodiment, the elongated element transfers at least a portion of the radiation at the IR range, transfers at least a portion of the radiation at the visible light range, transfers at least a portion of the radiation at the UV range or any combination thereof.

In one embodiment, the elongated element comprises at least one of: electrical wire(s), electrical cord(s), electrical element(s), electrical component(s), a connection to a power supply/current generator, or any combination or any number thereof.

In one embodiment, the elongated element comprises at least one light source such as a light emitting diode (LED), a lamp or any combination thereof, wherein said elongated element is configured to illuminate when connected to a power supply.

In one embodiment, the elongated element is a cord. In one embodiment, the elongated element is an electrical cord or an electrical wire. In one embodiment, the elongated element is a stripe. In one embodiment, the elongated element is selected from: a cord, a wire, a stripe, a hose, a tube, a string, a rope, a cable, a thread, a chain, or any combination thereof. In one embodiment, the elongated element has one dimension much larger than another dimension, e.g. the length of the elongated element is much larger than its width, its thickness, its cross-section, or a combination thereof.

In one embodiment, in methods of this invention, a drone lays an elongated element over (and/or around) a surface or over an object. In one embodiment, a drone of this invention assembles, puts, places, situates, disposes, dispenses, deposits, arranges, sets the elongated element over a surface or over an object to be covered/surrounded or marked. In one embodiment, a drone of this invention transfers, pulls, stretches, drives the elongated element over a surface or over an object, over a surface of an object, or over any combination thereof. In one embodiment, a drone of this invention transfers, pulls, stretches, drives the elongated element through a body of water or through any other liquid.

In one embodiment, the elongated element is used to cover a tree. According to this aspect and in one embodiment, the elongated element has for example the following dimensions: length=20 m, width=3 m, thickness=100 micrometers. According to this aspect and in one embodiment, the weight of the elongated element is about 6000 g (about 6 kg). Such weight can be carried by a drone. For example, a drone to carry such weight can be a 10-50 kg drone in one embodiment.

In one embodiment, the elongated element is a wire. According to this aspect and in one embodiment, the length of the wire is 50 m, its cross section is 1 cm², and it is made of a material having density of 0.92 g/cm³. The weight of such wire is approximately 4.6 kg in one embodiment. Such weight can be carried by a drone. For example, a drone to carry such weight can be a 5-50 kg drone in one embodiment. In one embodiment, the elongated element comprises low density polyethylene (LDPE). In one embodiment, in order to keep the weight of the elongated element low, the elongated element is made of light-weight material(s). In one embodiment, in order to keep the weight of the elongated element low, the elongated element is made of foamy material. In one embodiment, the material of the elongated element comprises Foamlite® having a density of 0.65 g/cm³. In one embodiment, the material from which the elongated element is made of comprises graphene. In one embodiment, the material from which the elongated element is made of comprises aerographene. In one embodiment, the elongated element comprises or consists of polyethylene (PE). In one embodiment, the density of the PE is 0.9 g/cm³. In one embodiment, a section of such an elongated element having a length and width of 1 m each and having a thickness of 100 μm, will weigh 90 g or approximately 90 g. Such weight is suitable for making elongated elements of the invention with longer lengths. Using such material in the form of a net or in the form of a porous material, further lowers its overall density, making it practical for embodiments of this invention. Any other material/forms as detailed herein above are included in embodiments of this invention. In one embodiment, the density of the elongated element's material is less than 0.9 g/cm³. In one embodiment, the density of the elongated element's material is less than 0.8 g/cm³. In one embodiment, the density of the elongated element's material is less than 0.5 g/cm³.

In one embodiment, in order to keep the weight of the elongated element low, the elongated element has the form of a net. In one embodiment, in order to keep the weight of the elongated element low, the elongated element is made of a material that is highly porous or highly perforated. In one embodiment, the density of the material of which the elongated element is made is lower than 1 g/cm³. In one embodiment, the density of the material of which the elongated element is made is lower than 0.9 g/cm³. In one embodiment, the density of the elongated element is lower than 0.9 g/cm³. In one embodiment, the density of the elongated element is lower than 0.8 g/cm³. Any combination of foam, net, porous, perforated, low density materials can be found in elongated elements of this invention. In one embodiment, the elongated element is wrapped around the roller. In one embodiment, the elongated element is rolled around the roller. In one embodiment, more than one elongated element is used with one drone. According to this aspect and in one embodiment, two or more elongated elements are assembled and are withdrawn from one roller. According to this aspect and in one embodiment, two or more elongated elements are assembled side by side on a single roller. In one embodiment, on one drone, two or more elongated elements are assembled independently on two or more rollers, and are each withdrawn from its corresponding roller. According to this aspect and in one embodiment, two or more rollers are mounted on a drone of this invention.

### Control Systems

In one embodiment, drone-control device or control systems of this invention comprise a remote drone-control systems as known in the art. In one embodiment, the control system (drone-control device) is continuously manually operated to control the drone's movement. In one embodiment, at least part of the drone's movement is pre-programmed, and the drone moves without continuous manual control. In one embodiment, at least part of the drone's movement is pre-programmed, and the drone's movement is autonomous. In one embodiment, movement of at least two drones is coordinated/synchronized. In one embodiment, movement of a fleet of drones is conducted in parallel. In one embodiment, movement of two or more drones is orchestrated. In one embodiment, operation of the control system is conducted VLOS (visual line of sight). VLOS represents drone-operation in which the remote pilot maintains continuous visual contact with the UAV, allowing control of the flight. In one embodiment, operation of the control system is conducted BVLOS (beyond visual line of sight). BVLOS represents an operation in which the drone/UAV is beyond visual line of sight of the remote pilot. In some embodiments, the drone/UAV is flown in a combination of VLOS and BVLOS modes. In one embodiment, the drone/UAV takes off and/or lands vertically. In one embodiment, vertical take-off and landing (VTOL) is the method by which a drone/UAV of this invention takes off and lands. In one embodiment, the drone/UAV takes off vertically, but lands in a non-vertical manner. In one embodiment, the drone/UAV takes off non-vertically, but lands in a vertical manner. In one embodiment, landing and take-off are non-vertical in drones/UAVs of this invention. In one embodiment, one remote pilot operates (flies) the drone. In one embodiment, more than one remote pilot operates (flies) the drone. In one embodiment, at least one remote pilot operates (flies) the drone and at least one observer assists the remote pilot(s). In one embodiment, the role of the observer is to communicate to the pilot(s) the position and/or the status of the drone by observing it. In one embodiment, the at least one pilot, or the at least one observer or a combination thereof are operating/flying/observing the drone/UAV from an outdoor area. In one embodiment, the at least one pilot, or the at least one observer or a combination thereof are operating/flying/observing the drone/UAV from an indoor area.

### Kits

In one embodiment, this invention comprises a kit. In one embodiment, a kit of this invention comprises an elongated element(s) and connection element(s) (comprised in, or separated from, the elongated element). In one embodiment, the kit further comprises a roller. In one embodiment, the kit comprises a roller having the elongated element already wrapped/rolled around it. In one embodiment, a kit of this invention comprises a drone, an elongated element, a roller, connection element(s), external mount, and a control system. In one embodiment, kits of this invention comprise any combination of two or more of the following elements/items: a drone, an elongated element, a roller, connection element(s), external mount, a control system. In one embodiment, the connection elements are comprised in the drone and/or in the elongated element, or are separated from the drone and/or from the elongated element. In one embodiment, the kit comprises a cartridge. In one embodiment, the cartridge comprises a roller. In one embodiment, the cartridge comprises a roller having an elongated element rolled around it. In one embodiment, the cartridge is designed to fit to an insertion area on the drone. In one embodiment, the cartridge is configured to be inserted into the drone or into a portion thereof. In one embodiment, the kit further comprises an instruction manual or a user guide. In one embodiment, kits of this invention further comprise a stand, a structure, or a feature to which the exposed end of the elongated element is attached. In one embodiment, kits of this invention comprise a roller comprising an elongated element wrapped around it, connection element(s) to connect the exposed end of the elongated element to an external feature.

### Definitions

In some embodiments of this invention, a ‘surface’ may refer to the surface of an object. According to this aspect and in one embodiment, covering a ‘surface’ and covering an ‘object’ are interchangeable and both refer to covering an object/a surface of the object. For example, covering an object may refer to covering a tree, covering a surface may refer to covering at least a portion of a surface of a tree.

In one embodiment, a drone is an unmanned aerial vehicle (UAV). In one embodiment, a drone comprises an unmanned aerial vehicle (UAV). In one embodiment, a drone comprises propellers.

In one embodiment, a classification differentiating autonomous vehicles from unmanned vehicles is referred to as described herein. It is to be noted that both autonomous vehicles (aerial and underwater) are included in this invention. In some embodiments, the use of a drone-control device is eliminated when an autonomous vehicle is referred to. In some embodiments, the use of a drone-control device is different when an autonomous vehicle is used instead of a remotely-controlled vehicle. All such drones (autonomous and remotely-operated) are included in embodiments of this invention. Embodiments of this invention are applicable to any class of drones and such embodiments are included in this invention. Any drone that is partially autonomous and partially remotely-operated is also included in embodiments of this invention and can be referred to in general as drone in embodiments of this invention.

In one embodiment, the term drone comprises a vehicle comprising propellers, or a fixed-wing or a combination thereof. In one embodiment, a drone comprises propellers but does not comprise fixed-wing. In one embodiment, a drone comprises fixed-wing but does not comprise a propeller.

In one embodiment, a control device is interchangeable with a control apparatus, a controlling apparatus, a control system, a controlling system. In one embodiment, the term ‘drone(s)’ refers to at least one drone, to one or more drones, to any number of drones.

In one embodiment, a covering element is any element capable of covering a surface, an object or at least a portion of a surface or of an object.

In one embodiment, a connection element is or comprises an anchor point, an anchor area or region, a connection point, a connection area or region, a connection feature, a connection element, or any combination thereof.

Some embodiments described herein for a rolled covering element are also applicable to a folded covering element and vice versa. All such embodiments are included in this invention.

In one embodiment, the term ‘located at’ can be exchanged with ‘located next to’, ‘located proximal to’, ‘adjacent to’ or any combination thereof. When referring to a location that is ‘at’ a point/region/feature or a location that is next to/adjacent to/proximal to/close to a point, region or a feature, the meaning is as known in the art. For example and in one embodiment, an anchor point (e.g. a connection element) placed proximal to an edge of a covering element may be placed between 0 cm and 30 cm from the edge, or between 0 cm and 20 cm from the edge, or between 0 cm and 10 cm from the edge in some embodiments. In some embodiments, ‘an anchor point placed at the edge’ may refer to an anchor point located exactly on/in the edge, or an anchor point located next to the edge or proximal to the edge. An anchor point next to the edge is referred to in some embodiments as an anchor point at the edge. This is a known way of description, especially when referring to large or elongated sheets.

In one embodiment, shift/lift means that for example a covering element or an edge/corner thereof is lifted, shifted, or is lifted and shifted.

In one embodiment, an elongated element has one dimension longer than another. According to this aspect and in one embodiment, the length of the elongated element is at least five meters or at least 10 meters or at least 50 meters or at least 100 meters or at least 1000 meters. In one embodiment, the ratio between the length and the width of an elongated element is at least 2 or at least 4 or at least 5 or at least 10 or at least 50 or at least 100 or at least 1000 or at least 10000. In one embodiment, the ratio between the length and the cross-section of an elongated element (e.g. a wire or a hose) is at least 1000, or at least 10000, or at least 100000, or at least 1000000. Other dimensions and dimension ratios are applicable to certain embodiments of this invention and are included in this invention. In one embodiment, the length of an elongated element is the longest dimension of the elongated element. In one embodiment, the width and thickness of an elongated element are measured perpendicular to the length. In one embodiment, the length and width are perpendicular to each other. For example, for a roll of an elongated sheet rolled on a roller, the width of the sheet is parallel to the longest dimension of the roller, the thickness of the sheet is substantially perpendicular to the longest dimension of the roller, the width of the sheet is larger than the thickness of the sheet and the length of the sheet is larger than the width of the sheet. In one embodiment, the cross section of the elongated element, taken perpendicular to the longest dimension (length) of the elongated element is circular. In one embodiment, the cross section of the elongated element, taken perpendicular to the longest dimension (length) of the elongated element is not circular. In one embodiment, the cross section of the elongated element taken perpendicular to the longest dimension (length) of the elongated element is rectangular. In one embodiment, the cross section of an elongated element is defined by width and thickness as described herein above. In one embodiment, the width of the elongated element is not equal to the thickness of the elongated element. In one embodiment, the width of the elongated element is different from the thickness of the elongated element. Any other shape/dimensions of a cross section of an elongated element is applicable to embodiments of this invention.

In one embodiment, the elongated element is anchored to an anchor point/region external to the drone during pulling of the elongated element.

In one embodiment, pulling of the elongated element means carrying the elongated element, spreading, shifting, transferring, stretching the elongated element. In one embodiment, the elongated element is pulled, carried, spreads, drags, shifts, transferred, stretched, laid, over or next to or under, or in proximity to a certain area/surface.

In one embodiment, an anchor point refers also to an anchor region, an anchor area and vice versa. Such terms are interchangeable in some embodiments of this invention. In some embodiments, anchor point or anchor region are referred to as “anchor”.

In one embodiment, the elongated sheet/element is a blanket. In one embodiment, a combination of a single item and a plurality of items is designated as “item(s)”. Such designation means that one item, or more than one item, is/are included in this designation in some embodiments of this invention. Such designation applies to a single item and to more than one item in certain embodiments of this invention.

In one embodiment, the term ‘pulls’ is exchangeable with the term ‘transfers’. In one embodiment, the term ‘pulling’ is exchangeable with the term ‘transferring’.

In one embodiment, the term ‘covering element’ is interchangeable with the term ‘elongated element’. In some embodiment, the term ‘elongated covering element’ is interchangeable with an ‘elongated element’, with a ‘covering element’ or with an ‘elongated/covering element’.

In one embodiment, the terms ‘connect’, ‘attach’, ‘join’, ‘link’, or ‘make contact with’ are interchangeable. In one embodiment, the terms ‘connecting’, ‘attaching’, ‘contacting’, ‘linking’, ‘joining’ are interchangeable. In one embodiment, the terms ‘configured’, ‘placed’, ‘located’ are interchangeable. It is to be noted that the number of drones in a figure are illustrated as an example for simplicity. In some embodiments shown in the figures, one drone can be replaced with two drones and vice versa.

In one embodiment, the term “a” or “one” or “an” refers to at least one. In one embodiment the phrase “two or more” may be of any denomination, which will suit a particular purpose. In one embodiment, “about” or “approximately” or “substantially” may comprise a deviance from the indicated term of ±1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%. In one embodiment, “about” or “approximately” or “substantially” comprise the exact value. In one In one embodiment, “about” or “approximately” or “substantially” comprise the exact value/term and a deviance as described herein above.

### EXAMPLES

Examples of Covering Methods of this Invention

### Example 1

In one embodiment, (see FIG. 1) a method of covering a line of fruit-trees is provided. A covering element (110) in the form of a rolled sheet is provided on a roller and the roller is attached to a drone (100). The exposed edge of the covering element comprises two-ten anchor points or an anchor line, assembled along the exposed edge. The exposed edge is attached to an external mount (140). Once the covering element is connected to the external mount, the drone is moved away from the mount. The movement of the drone is controlled such that the drone pulls and transfers the covering element on top of the fruit-trees and along the fruit-tree line. The drone movement causes a portion of the rolled covering element to be dispensed (to be rolled-out) from the roller and to cover the trees. Once the covering element covers the entire fruit-tree line, the drone is controlled to lower the covering element onto or proximal to the ground. The drone is then manually disengaged from the covering element. The covering element now covers the entire line of fruit-tree. The sides of the covering element are secured to the ground or to the bark or to lower branches of the tree using anchor points or elements on the two long edges along the length of the covering element (see such anchoring point for example in FIG. 5, elements 570). In one embodiment, the sides of the covering element are left non-secured to any additional feature.

### Example 2

In one embodiment, (see for example in FIG. 7) a method of covering a construction is provided. A covering element in the form of a rolled elongated sheet is provided and is attached to two drones. An anchor on the ground on a first side of the construction is manually connected to anchor points on the covering element (note that the width of the covering element is not shown in the Figure for simplicity). Once the ground anchor is connected to the covering element, the movement of the two drones is initiated. The movement of the drones is controlled such that the two drones pull and transfer the covering element onto the top of the construction to be covered. The movement of the two drones is coordinated. Once the covering element is located above the top of the construction, or once it covers the top of the construction, the drones are controlled to either lower the edge of the covering element along a side opposite to the first side of the construction, or the drones are then automatically disengaged from the covering element, or from the roller itself, thus leaving/dropping the covering element on the opposite side of the construction. The covering element now covers the construction. The sides of the covering elements are secured to the ground or to side construction poles of the construction using anchor points or elements located adjacent to the corners or adjacent to edges of the covering element.

It is to be noted that sequences of steps as described herein above for methods of this invention are just an example. Other sequences, or steps that are conducted in parallel, or steps that are divided to sub-steps, or steps that are performed in a different order etc., are all part of methods of this invention and are apparent to any person of ordinary skill in the art.

### Example 3

In one embodiment, (see for example FIG. 3 and FIG. 4) a method of covering the sides of a construction is provided. A covering element in the form of a rolled sheet is provided on a roller. The roller is placed vertically with respect to the ground. The exposed edge of the covering element comprises one-ten anchor points or an anchor line is assembled along the exposed edge. The edge of the covering element is manually connected to one or more anchor points on the construction. Once the exposed edge of the covering element is connected to e.g. one pole of the construction, the movement of the drone(s) is controlled such that the drone(s) pull and transfer the covering element around the poles of a construction (see FIG. 3 and FIG. 4). As the drone moves, portions of the elongated element are dispensed from the roller on the drone. If two drones are used (FIG. 3), the movement of the two drones is coordinated. Once the covering element wraps around the entire construction, or any desired portion of it, the drone(s) is/are controlled to stop moving. The drone(s) is/are then manually or automatically disengaged from the covering element. The covering element now covers the sides of the construction. In one embodiment, this method enables to form protective flexible walls around a construction. As an example, such covering is used in one embodiment to form walls for a greenhouse, to form a temporary sheltered region, to form a living/camping housing, to form a border or a fence etc.

### Example 4

In one embodiment, a method of marking a line or a region in a field is provided. A covering element in the form of a rolled stripe is provided on a roller and the roller is connected to a drone. The exposed edge of the covering element comprises one anchor point. One anchor external to the drone (e.g. on the ground) is manually connected to the anchor point on (or proximal to) the edge of the rolled stripe. Once the covering element (marking stripe) is connected to the external anchor, the drone is controlled to move such that the drone pulls and transfers the stripe along a line in the field. Once the stripe covers and marks the entire line, the drone is controlled to stop, or to go around one or more poles, such that it continues to pull the stripe in a different direction or along a different line. Once all lines, or the desired region, are/is marked by the stripe as desired, the drone is manually or automatically disengages from the covering element, from a portion of the covering element, or from the roller with or without a remaining portion of covering element on it. For certain applications, the stripe may be luminescent, it may glow in the dark, it may be of any color, or combination of colors, it can comprise electrical wires and LED's/lamps that can be lit using a power supply. Such power supply can be placed anywhere along the length of the stripe, for example at the beginning/end of the stripe or somewhere along the stripe. Such power supply can be placed externally to the stripe and be connected to it when required. Line marking as described in this example can be used for landing of aerial vehicles, for marking an area for landscaping/for construction, marking borders between farming regions, marking a non-entry region etc. as detailed herein above.

### Example 5

In one embodiment, systems and methods of this invention are used for rescue. According to this aspect and in one embodiment, systems and methods of this invention are used to transfer supplies to humans or animals that are in need. According to this aspect and in one embodiment, systems and methods of this invention are used to transfer supplies to humans/animals in a disaster area, to humans/animals that are stranded or confined to an area, to humans/animals that are located in a secluded area, in a mine, under ruins/rubble, in an area that is hard to reach by foot or by car. In one embodiment, systems and methods of this invention are used to transfer supplies underwater to personnel in a submarine, to divers, to humans/animals stranded in a cavern with underwater access etc. In one embodiment, methods of this invention comprise transfer of an electrical cord, a power cable, a water tube/hose, a gas tube (e.g. air/oxygen), a hose comprising first aid, disinfectant, antiseptic, pharmaceutical agents etc. According to this aspect and in one embodiment, a cord, a tube, a hose, a cable, a rope, or a wire is being pulled by at least one drone over, under or to the side of an obstacle or an otherwise non-accessible region to an area where humans/animal in need are located. According to this aspect and in one embodiment, once the cord, tube, hose, or wire reaches the desired region, supply transfer commences. According to this aspect and in one embodiment, water, electricity, gases, liquids, or any combination thereof is supplied. In some embodiments, certain solids can also be transferred to such distant location by systems and methods of this invention. Examples for obstacles over, under or to the side of which, the elongated element of this invention is pulled/transferred are: a mountain, a river, a cliff, a reservoir, a water-filled region, a non-accessible terrain, an area comprising dense flora/vegetation, an area comprising mud, a swamp, an area comprising rocks/boulders, an area comprising ruins/rubble, an area comprising predators, a mine, a cavern, or any combination thereof. Any other area that is inaccessible or hardly accessible by other means (e.g. foot/car/truck), is an area where systems and methods of this invention apply for. In one embodiment, once the cord/hose/tube is transferred (pulled) to the desired area, supply can be transferred with the aid of a pump, gravity, or any other pressure/vacuum inducing elements/devices and systems as known in the art. In one embodiment, for transfer of electricity/power, the wire/cord is connected to a power supply on the side, or in proximity to the side, from which it was pulled by methods of this invention. In one embodiment, a rope is transferred by systems and methods of this invention to an area where stranded humans/animals are located. Such rope/cable may allow the stranded humans to extract themselves from the stranded area. Such rope allows rescuers to reach the stranded area. According to this aspect and in some embodiments, supplies can be transferred using such rope/cable by any means know in the art, for examples using one or more of the following features: a hanging package, zip-line, pulley, a roller-based system, rollers, clips, carabiners, additional mounting fixtures, additional transfer features and any other feature/element as known in the art. In one embodiment, supplies are transferred to the desired rescue area as follows: a roller is mounted on a fixture on the rescuers side. An elongated element in the form of a cord or a cable comprising the supplies in it or on it, is wrapped around the roller. The drone is attached to the exposed end of the cord/cable and it pulls the elongated element. The drone transfers the exposed end of the elongated element to the required rescue region. Once an edge of the cord/cable (or any other elongated element) reaches e.g. the stranded humans, the cord/cable is optionally disconnected from the drone. The stranded humans can then pull the cord/cable to their side, until the entire cord/cable or any portion thereof reaches the area in need for supplies. The supplies that were carried within, or on, the cord/cable, are now available for the humans (and optionally for animals). According to this aspect and in one embodiment, the cord/cable may comprise food, nutrients, water containers, medicine, first aid etc. In one embodiment, continuous supply is now available by using portions of the pulled cable. In one embodiment, continuous supply is now available by pulling additional portions of the cable by the stranded humans. In one embodiment, the cord/cable comprising the supplies is attached to a lighter elongated element and this lighter elongated element is pulled by the drone to the area in need. Once the lighter cable/cord reaches the e.g. stranded humans, they can pull this cord/cable and further pull the supply cable attached to it so that supplies can reach their destination. In one embodiment, such method allows subsequent continuous transfer of supplies. According to this aspect and in one embodiment, this invention provides an elongated element comprising supplies. According to this aspect and in one embodiment, this invention provides an elongated element comprising one or more of: food, nutrients, water containers, medicine, medical devices, first aid elements, cloths, disinfectants, lighting materials, lighters, or any combination thereof. According to this aspect and in one embodiment, this invention provides an elongated element comprising supplies, rolled on a roller. According to this aspect and in one embodiment, this invention provides: a first elongated element comprising supplies, the first elongated element is connected to a second elongated element. In one embodiment, the second elongated element is lighter in weight per one unit length than the weight of the supply cable per one unit length.

Those skilled in the art to which this invention pertains will readily appreciate that numerous changes, variations, and modifications can be made without departing from the scope of the presently disclosed subject matter, mutatis mutandis. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the 10 invention.

1. A method for covering at least one surface, at least one object or a combination thereof, said method comprising:
providing a system comprising:
at least one drone;
a roller connected to said drone;
an elongated element comprising a first end and a second end, said element is wrapped around said roller;
a drone-control device;
wherein said first end of said elongated element is connected to said roller;
said second end of said elongated element is configured to be connected to an external anchor point/region located on an object external to said drone;
wherein when said elongated element is connected to said external anchor point/region, and when said drone is moving, the drone is capable of pulling said elongated element over at least one surface, at least one object or a combination thereof;
connecting said second end of said elongated element to said external anchor point/region;
using said drone-control device to move said drone, such that said drone pulls said elongated element over said at least one surface, over said at least one object or a combination thereof, thus covering said at least one surface, said at least one object or a combination thereof.

2. The method of claim 1, wherein said drone-control device controls the movement of said drone.

3. (canceled)

4. The method of claim 1, wherein said drone pulls said covering elongated element over a field, over a tree, over a line of trees, over an orchard, over a bush, over a line of bushes, over a field of bushes, over a building, over a line of buildings, over a region of buildings, over a geographical area, over a mountain, over a cliff, over a river, over a logistical area, over a water reservoir, over a car lot, over a truck lot, over a road, over a street, over a forest, over a supply camp, over an assembly area, over a gathering area, over an animal, over a group of animals, over a storage area, over a territory, over a piece of land, over an area, over a lot, over a yard, over a portion of the ground, over a balcony, or over any portion or any combination thereof.

5. The method of claim 1, wherein said drone is capable of moving in any direction.

6. The method of claim 1, wherein said drone is capable of moving in multiple directions.

7. The method of claim 5, wherein the movement of said drone is selected from: up, down, horizontally at any direction, in a straight line, forming a circular pattern, forming an oval pattern, forming a square, forming a rectangle, a sinusoidal form, or any combination thereof.

8. The method of claim 1, wherein the connection of said roller to said first end of said elongated element comprises: connection of said roller to one anchor point on said first end, to two anchor points on said first end, to more than two anchor points on said first end, to a line on said first end, to at least one patch on said first end, to at least one region on said first end, or a combination thereof.

9. The method of claim 1, wherein said elongated element is in the form of a roll wound on said roller.

10. The method of claim 1, wherein said at least one drone comprises two drones such that each of said two drones is independently connected to a different portion of said roller, and wherein when said elongated element is connected to an external anchor point, said two drones simultaneously pull said roller, thus pulling said elongated element.

11. The method of claim 1, wherein said external anchor point is located on an external elevated fixture, such that the height of said anchor point is higher than the surface or the object over which said elongated element is pulled.

12. The method of claim 1, wherein:
said elongated element is in the form of an elongated sheet and wherein said elongated sheet is rolled on said roller;
said second end of said elongated element is connected to said external anchor point located on an external elevated fixture, such that the height of said anchor point is higher than the surface or the object over which said elongated element is pulled;
said at least one drone pulls said elongated element over said surface or over said object, or over any combination thereof.

13. The method of claim 1, wherein said drone pulls said elongated element as follows:
pulling up next to a first side of the at least one object;
pulling over said object, to a side opposing said first side;
optionally pulling down along said opposing side.

14. The method of claim 1, wherein following positioning of said elongated element over said surface/object:
a portion of said elongated element is disconnected from said roller; or
said drone disconnects from said roller; or
said drone lands on an area proximal to said surface/said object; or
a combination thereof.

15. The method of claim 14, wherein:
following disconnection of a portion of said elongated element from said roller; or
following disconnection of said drone from said roller; or
a combination thereof,
said drone returns home (RH).

16. The method of claim 14, wherein:
a portion of said elongated element, proximal to said roller is cut, such that a remaining portion of said elongated element remains wound on said roller; or
said first end of said elongated element is disconnected from said roller.

17. The method of claim 14, wherein any of said disconnections is automatically performed by the drone or wherein any of said disconnections is performed manually.

18. The method of claim 16, wherein any of said disconnections is automatically performed by the drone or wherein any of said disconnections is performed manually.

19. The method of claim 1, wherein said elongated element is in the form of a stripe, a cord, a tube, a wire, a cable, or a hose.

20. The method of claim 1, wherein said covering method is used for an application selected from: protecting fruit on fruit-trees from birds and/or from insects/pests, protecting a surface from sun/rain/wind/moisture, protecting a liquid reservoir from liquid evaporation, mark a region or an area for spraying, planting, seeding, mark an area for airplane landing, mark an area for landscaping, defining borders between geographical/farming regions, protecting a seeded area from pests/insects, protecting a crop region from pests/insects, selective seeding or planting in portions of a field, selective irrigation of portions of a field, protecting a building during renovation, decorating a building, catching an animal or a group of animals for their rescue, generating a roof over a building/structure, generating walls for a building/structure, transferring water/electricity/supplies to remote or inaccessible areas, or any combination thereof.

21. The method of claim 1, wherein the elongated element comprises a sheet, a web, a fabric, a blanket, a woven material, a foil, a net, a plastic sheet, a cloth, a paper, or any combination thereof.
